(19) United States
(12) Patent Application Publication
(10) Pub. No.: US 2016/0103625 A1
(43) Pub. Date: Apr. 14, 2016

(54) DEVICE, HOST APPARATUS, HOST SYSTEM, AND MEMORY SYSTEM

(71) Applicant: Kabushiki Kaisha Toshiba, Minato-ku (JP)

(72) Inventors: Akihisa FUJIMOTO, Yamato (JP); Hiroyuki SAKAMOTO, Ome (JP); Shinichi MATSUKAWA, Tokyo (JP)

(73) Assignee: Kabushiki Kaisha Toshiba, Minato-ku (JP)

(21) Appl. No.: 14/974,665

(22) Filed: Dec. 18, 2015

Related U.S. Application Data
(63) Continuation of application No. PCT/JP2014/053391, filed on Feb. 6, 2014.

(30) Foreign Application Priority Data
Jun. 20, 2013 (JP) 2013-129832
Feb. 4, 2014 (JP) 2014-019731

(51) Int. Cl. G06F 3/06

(52) U.S. Cl. CPC G06F 3/0622; G06F 3/0637; G06F 3/0679

(57) ABSTRACT

According to one embodiment, a device includes a semiconductor memory and a controller. The semiconductor memory includes first and second areas which are accessible from an outside. The controller controls the semiconductor memory. The device includes an unlocked state where accessing the first area is allowed, and a locked state where the accessing the first area is prohibited. The device is capable of holding one or more user key in the device. The device includes a function of configuration operation to register, change, and delete the user key in the semiconductor memory.

### CROSS-REFERENCE TO RELATED APPLICATIONS

This application is a Continuation Application of PCT Application No. PCT/JP2014/053391, filed Feb. 6, 2014 and based upon and claiming the benefit of priority from prior Japanese Patent Application No. 2013-129832, filed Jun. 20, 2013; and No. 2014-019731, filed Feb. 4, 2014, the entire contents of all which are incorporated herein by reference.

### FIELD

The embodiments described herein relate generally to a device, a host apparatus, a host system, and a memory system.

### BACKGROUND

As a recording medium, a memory device using a NAND flash memory has broadly prevailed.

As such a memory device, a memory card is known. Further, there is known the memory card having a lock function of prohibiting an access to the card. However, according to the conventional lock function, a memory area cannot be read at all in a locked state, and hence there has been the problem that the memory card is not recognized by a host apparatus which does not support the lock function. Furthermore, even a host apparatus supporting the lock function cannot access the memory card until the locked state is released, and hence it cannot be distinguished whether the access is impossible due to the locked state or due to an error. To manage the locked state, a special utility is required. Consequently, in the host apparatus, it has been difficult to manage the handling of the card which is in the locked state.

### BRIEF DESCRIPTION OF THE DRAWINGS

FIG. 1 is a block diagram of a memory system according to one embodiment;

FIG. 2 is a concept diagram of a memory space of the memory system according to the one embodiment;

FIG. 3 and FIG. 4 are state transition diagrams of a memory card according to the one embodiment;

FIG. 5 is a block diagram of the memory system according to the one embodiment;

FIG. 6 is a flowchart showing an operation of the memory card according to the one embodiment;

FIG. 7 is a diagram showing a function of a configuration mode according to the one embodiment;

FIG. 8 is a flowchart showing an operation of a host apparatus during execution of a “Set User Key” function according to the one embodiment;

FIG. 9 is a flowchart showing an operation of the memory card during the execution of the “Set User Key” function according to the one embodiment;

FIG. 10 is a flowchart showing an operation during the execution of the “Set User Key” function according to the one embodiment;

FIG. 11 is a flowchart showing an operation during the execution of the “Set User Key” function according to the one embodiment;

FIG. 12 is a flowchart showing an operation of the host apparatus during execution of a “Clear/Verify User Key” function and “Enable/Disable Key Ciphering” according to the one embodiment;

FIG. 13 is a flowchart showing an operation of the memory card during the execution of the “Clear/Verify User Key” function according to the one embodiment;

FIG. 14 is a flowchart showing an operation during the execution of a “Clear User Key” function according to the one embodiment;

FIG. 15 is a flowchart showing an operation during the execution of the “Clear User Key” function according to the one embodiment;

FIG. 16 is a flowchart showing an operation of the memory card during the execution of the “Enable/Disable Key Ciphering” according to the one embodiment;

FIG. 17 is a flowchart showing an operation of the memory card during execution of “Enable/Disable Config. Mode” according to the one embodiment;

FIG. 18 is a flowchart of an unlocking operation according to the one embodiment;

FIG. 19 is a flowchart of the unlocking operation in the host apparatus according to the one embodiment;

FIG. 20 is a flowchart of the unlocking operation in the memory card according to the one embodiment;

FIG. 21 to FIG. 24 are flowcharts of the unlocking operation according to the one embodiment;

FIG. 25 is a flowchart of a locking operation in the host apparatus according to the one embodiment;

FIG. 26 is a flowchart of the locking operation in the memory card according to the one embodiment;

FIG. 27 is a schematic view of the memory system according to the one embodiment;

FIG. 28 to FIG. 33 are schematic views of the memory system according to the one embodiment;

FIG. 34 is a block diagram of a memory system according to a modification of the one embodiment;

FIG. 35 is a block diagram of a partial area of a memory card according to the modification of the one embodiment; and

FIG. 36 is a flowchart showing an operation of the memory card according to the modification of the one embodiment.

### DETAILED DESCRIPTION

In general, according to one embodiment, a device includes: a semiconductor memory including a first area which is accessible from an outside through an interface connecting between a host and the device; and a controller which controls the semiconductor memory. The device includes an unlocked state where accessing the first area is allowed, and a locked state where the accessing the first area is prohibited. The device is capable of holding one or more user key in the device. The device includes a function of configuration operation to register, change, and delete the user key in the semiconductor memory. After power is turned on, the device is either in the locked state if any of user keys is registered or in the unlocked state if none of user keys is registered. An initialization sequence is executed regardless of the device is in the locked state or the unlocked state. In the unlocked state, the device allows for access of the first area and execution of a configuration operation, In the locked state, the device prohibits accessing the first area and is configured either in a first mode or in a second mode, In the first mode of the locked state, the device allows for execution of the configuration operation, and prohibits change to the unlocked state, and in the second mode of the locked state, the device prohibits execution of the configuration operation and allows for change to the unlocked state when the comparison result is matched between a key received from the outside through the interface and one of the user keys registered in the device.

The device, a host apparatus, a host system and a memory system according to the one embodiment will be described. Hereinafter, the memory system including a memory card and the host apparatus which accesses this memory card will be described as an example. Moreover, in the present description, a case where the memory card is an SD memory card will be described as an example.

1. Structure of System

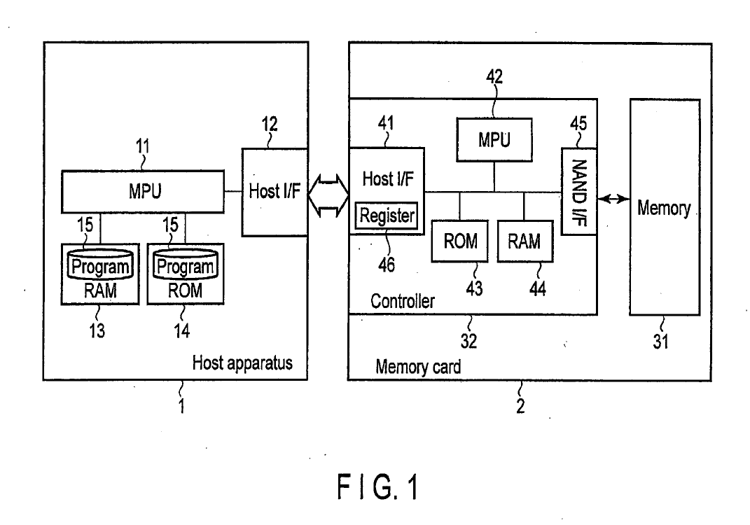

First, structure of the host apparatus and the memory card will be described with reference to FIG. 1. FIG. 1 is a block diagram showing a hardware structure of the memory system according to the present embodiment.

1.1 Structure of Host Apparatus

First, the structure of the host apparatus will be described with reference to FIG. 1. As shown in the drawing, a host apparatus 1 includes a micro processing unit (MPU) 11, a host interface (e.g., SD™ interface) circuit 12, a read only memory (ROM) 14, a random access memory (RAM) 13 and the like. The ROM 14 includes a storage device such as a hard disk which enables general writing, and the ROM is not especially restricted by a type of hardware.

The MPU 11 controls the whole operation of the host apparatus 1. When the host apparatus 1 receives power supply, a firmware (a control program (a command)) stored in the ROM 14 is read onto the RAM 13. Then, the MPU 11 executes predetermined processing in accordance with the firmware (the command). Moreover, the MPU 11 executes programs 15 held in the RAM 13 and the ROM 14, thereby realizing various functions. The programs 15 include various pieces of application software, operating systems, file systems, and the like. Furthermore, the program 15 includes a management utility for preparing a user key described later.

The host interface circuit 12 manages a communication protocol between this circuit and a memory card 2. The host interface circuit 12 operates in accordance with various agreements required to perform communication between the host apparatus 1 and the memory card 2, and comprises various sets of commands which can mutually be communicated with a host interface 41 of the memory card 2 described later.

1.2 Structure of Memory Card

Next, the structure of the memory card 2 will be described continuously with reference to FIG. 1. As shown in the drawing, the memory card 2 includes a NAND flash memory 31 and a controller 32.

The NAND flash memory 31 stores data in a nonvolatile manner. The NAND flash memory 31 writes or reads the data in units called pages including a plurality of the memory cells. An inherent physical address is allocated to each page. Furthermore, the NAND flash memory 31 erases the data in units called blocks, including a plurality of the pages. It is to be noted that the physical address may be allocated to the block unit.

The controller 32 instructs the NAND flash memory 31 to write, read, and erase the data in response to a request from the host apparatus 1. Moreover, the controller 32 manages a stored state of the data in the NAND flash memory 31. The management of the stored state includes the management of a relationship between the logical address and the physical address, and the management of whether a specific physical address page (or block) is in an erased state (a state where nothing is written or invalid data is held).

As shown in FIG. 1, the controller 32 includes the host interface circuit 41, an MPU 42, a RAM 44, a ROM 43, and a NAND interface circuit 45.

The host interface circuit 41 controls the communication between the memory card 2 and the host apparatus 1. More specifically, the host interface circuit 41 controls transmission/reception of various commands or data between the host interface circuit and the host interface circuit 12 of the host apparatus 1. Moreover, the host interface circuit 41 includes a register 46. The register 46 stores various pieces of information, whereby the host apparatus 1 can be notified of the state of the memory card 2. This information is set, for example, by the MPU 42. Furthermore, the register 46 stores various pieces of information received from the host apparatus 1.

The MPU 42 controls the whole operation of the memory card 2. When the memory card 2 receives the power supply, firmware (a control program (a command)) stored in the ROM 43 is read onto the RAM 44. Then, the MPU 42 executes predetermined processing in accordance with the firmware (the command). The MPU 42 prepares various tables on the RAM 44 in accordance with the control program, or executes predetermined processing for the NAND flash memory 31 in accordance with the command received from the host apparatus 1.

The ROM 43 stores the control program or the like to be controlled by the MPU 42. The RAM 44 is used as an operation area of the MPU 42, and temporarily stores the control program or various tables. These tables include a conversion table (a logical address/physical address conversion table) of the logical address allocated to the data and the physical address of the page in which the data is stored. The NAND interface circuit 45 performs interface processing between the controller 32 and the NAND flash memory 31.

1.3 Memory Space of Memory System

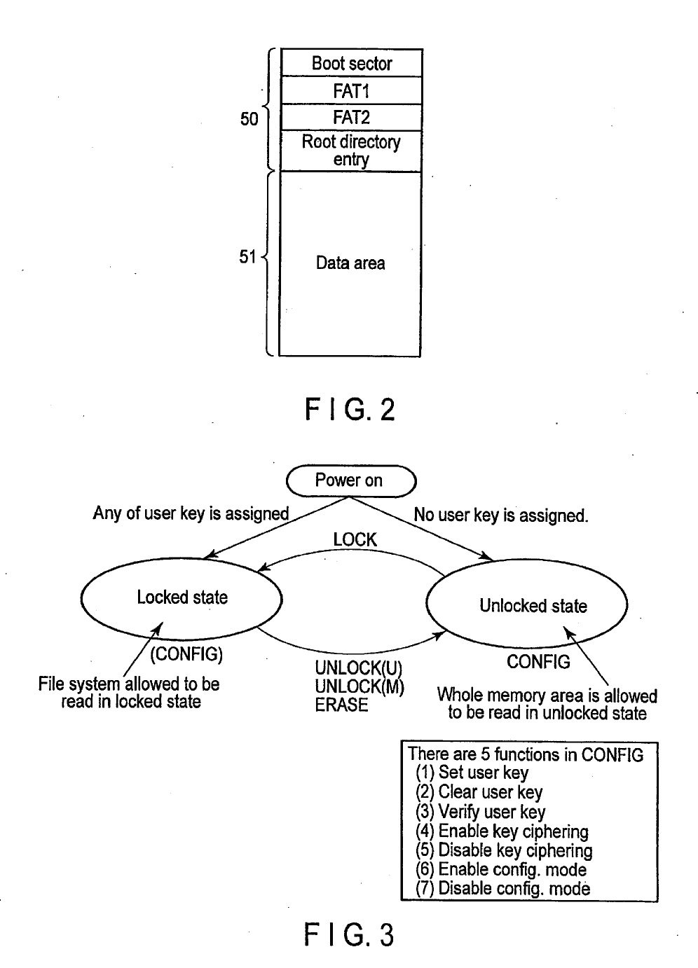

Next, a memory space of the memory system of the above structure will be described. FIG. 2 is a memory map showing the memory space which is accessible from the outside of the memory card 2, and shows an example where the memory space is managed by a file allocation table (FAT) file system.

As shown in the drawing, the memory space is roughly divided into a file system management area 50 and a file system data area 51. Each area is divided into units called clusters, and controlled in the cluster unit. A combination of the file system management area 50 and the file system data area 51 is called a data area.

The management area 50 is disposed to manage a file (data) recorded in the NAND flash memory 31, and it holds management information of the file. A system to manage the file (the data) recorded in the memory in this way is called a file system. In the file system, there are set up a preparing method of directory information of the file, a folder or the like, a moving method or deleting method of the file, the folder or the like, a recording system of the data, a location or a utilizing method of the management area, and the like.

The management area 50 includes, for example, a boot sector, a FAT1, a FAT2, and a root directory entry. The boot sector is an area where boot information is stored. The boot sector includes, for example, a master boot record (MBR) and a BIOS parameter block (BPB). Each of the MBR and the BPB is, for example, a 512 byte area. The FAT1 and the FAT2 store specific clusters in which the data is stored. The memory space is a set of spaces each having a definite size which are called clusters. Moreover, when the data to be written is larger than the cluster size, the data is divided into cluster units, and stored therein. In this case, in the FAT, there is prepared a cluster chain indicating specific clusters into which the data is divided and written, whereby the data is managed. It is to be noted that both the FAT1 and the FAT2 hold the same value, which enables the recovery of the FAT even when one of the FAT1 and FAT2. Hereinafter, the FAT1 and the FAT2 will collectively be called the FAT. The root directory entry stores information of the file present on a root directory. More specifically, together with a file name or a folder name, a file size, an attribute, update date and time of the file and the like, a specific cluster which is the top cluster of the file is stored. When the top cluster is known, all the data is accessible from a FAT chain.

The file system data area 51 is an area other than the management area 50, and a data capacity which can be stored in the memory card depends upon a size of this area. Moreover, the area holds net user data or directory entry.

1.4 Locked State and Unlocked State

Next, the locked state and the unlocked state which can be taken by the memory card 2 according to the present embodiment will be described with reference to FIG. 3. FIG. 3 is a state transition diagram of the memory card 2, and especially shows a state immediately after power is turned on, and a transition between the locked state and the unlocked state.

To bring the memory card into the locked state, the user key needs to be registered, and is required to perform the transition between the locked state and the unlocked state. There are a case where the key is used as “a password” to be directly input from the host apparatus 1 by a user, and a case where the key is managed by the management utility of the host apparatus 1 without inputting the password by the user, because a key which is so long as to be unsuitable for the user to input is also handled.

As shown in FIG. 3, when the memory card 2 is connected to the host apparatus 1 and the power is supplied from the host apparatus 1 to the memory card 2, the memory card 2 takes one of the locked state and the unlocked state in accordance with the presence/absence of the setting of the user key. When the user key is not set, the memory card 2 becomes in the unlocked state. In the unlocked state, a writing access and a reading access to the memory space of the memory card 2 can be performed without limit (with the proviso that the writing is limited by a use application of a ROM card or the like sometimes). The control of the memory card is executed in accordance with a command, and examples of a memory access command include a writing command, a reading command, and a control command to control the lock function of the present embodiment. The host apparatus 1 can register the user key in the memory card 2 by use of the control command. The control command is controlled as an executable command irrespective of the locked state or the unlocked state.

On the other hand, when the user key is set to the memory card 2, the memory card 2 becomes in the locked state. In the locked state, the writing access to the memory card 2 is prohibited, and the reading access is limited. For example, the management area 50 described with reference to FIG. 2, more specifically, information on the file system (e.g., the FAT1, FAT2 and root directory entry in FIG. 2, which will hereinafter be called the file system information) can be read, but when the reading command for the area other than the management area 50 is received, the execution of the command is rejected. When the writing command is received, the execution of the command is rejected irrespective of the area.

The host apparatus 1 can read at least a part of the file system information even when the memory card 2 is in the locked state. Therefore, when the file system information is read, the host apparatus can recognize the memory card 2 as a formatted memory device, and can further allocate a drive letter to the memory card 2.

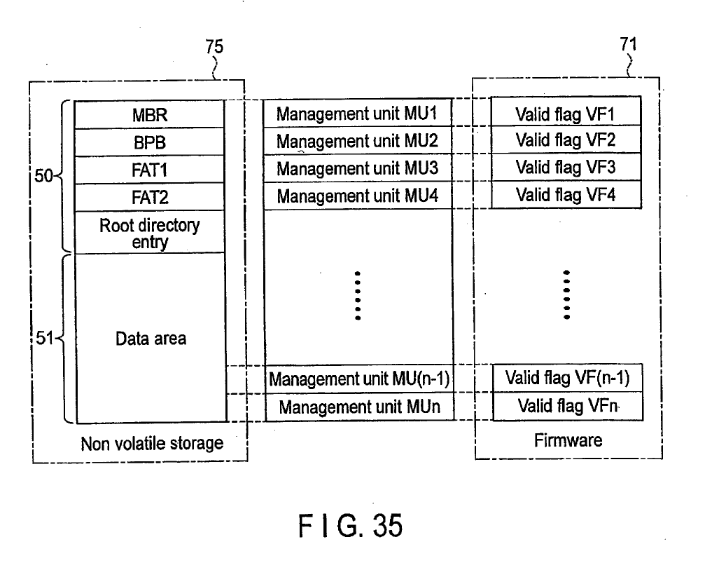

For example, in the host apparatus 1, when only the information stored in a master boot record (MBR) described later and shown in FIG. 35 is read, the memory card 2 can be mounted. In this case, the host apparatus 1 controls the memory card such that, when the card is in the locked state, the card is shown as an empty drive, and when the card is in the unlocked state, the directory or the file name stored in the card can be read.

A boundary between the file system management area 50 and the file system data area 51 depends upon a format parameter of the file system, and hence the memory card 2 does not need to strictly distinguish the boundary. The required size of the management area 50 can roughly be predicted from the memory capacity. Therefore, in the locked state, for example, the MBR or BPS may be read, or a little larger area including the management area 50 may be read. In consequence, the memory card 2 does not have to recognize a format of the file system.

In general, when the device is mounted, the identification of the device and partition information are required. Therefore, when the MBR can be read at minimum in the locked state, the memory card 2 can often be mounted. Device information can be identified by reading the MID, after the memory card 2 is initialized. The MID is a type of card identification information which is held in a card identification (CID) register included in the memory card 2. Furthermore, the MBR is information required to obtain the partition information of the memory card 2. However, when a rule indicating that an only first partition of the memory card 2 is valid is determined in advance, the memory card 2 can be mounted without reading the MBR. As one example of the host apparatus 1 which can read the memory card 2 in the locked state, the following case can be considered as one example in the case of a memory system of FIG. 35. That is, for mounting the memory card2, the host apparatus 1:

(a) can read the MBR only,

(b) can read the MBR and BPB only,

(c) can read from the MBR to the FAT, or

(d) can read from the MBR to the root directory entry.

When the memory card 2 in the unlocked state executes a locking operation by use of the control command, and when the user key is registered, the memory card can change to the locked state. Furthermore, when the memory card 2 in the locked state executes an unlocking operation by use of the control command, and when a designated key matches the registered key, the memory card can change to the unlocked state. Examples of the unlocking operation include an unlocking operation using the user key, and an unlocking operation using a master key described later. Furthermore, the locked state can be changed to the unlocked state also by erasing a part of the data including the user key in accordance with the control command. Details of these operations will be described later.

Additionally, in the memory card 2, various settings (configuration operations) concerning the user key are executable by using the control command. This configuration operation is usually executable in the unlocked state, but the memory card has a configuration mode (Config. Mode) which can allow the configuration operation even in the locked state. That is, the memory card 2 in which the configuration mode is in the on-state can execute the configuration operation even in the locked state. On the other hand, when the configuration mode is in the off-state, the memory card 2 in the locked state cannot execute the configuration operation. Details of the configuration operation will be described later.

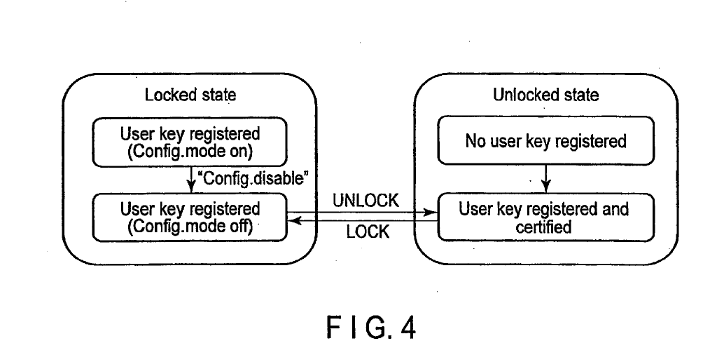

FIG. 4 is a diagram showing internal states of the locked state and the unlocked state in more detail. As described above, if the user key is not registered when the power is turned on, the memory card 2 is in the unlocked state. In the unlocked state (on the right side of FIG. 4), the configuration mode is the on-state at default setting. Furthermore, the host apparatus 1 executes the configuration operation by use of the control command to register the user key. On the other hand, if the user key is registered when the power is turned on, the memory card 2 is in the locked state (on the left side of FIG. 4). There are two states where the configuration mode is on and off. When the configuration mode is the off-state, the unlocking operation cannot be executed.

For example, when the memory card 2 in which the user key is registered by a certain host apparatus 1 (a host apparatus 1-1) is connected to another host apparatus 1 (a host apparatus 1-2), the memory card 2 becomes in the locked state. However, when the configuration mode is set to the on-state by the host apparatus 1-1, the host apparatus 1-2 can set the user key to the memory card 2 in the locked state. Afterward, when the host apparatus 1-2 set the configuration mode to the off-state, the configuration operation cannot be executed.

The user keys can be registered, and the user keys of the host apparatuses to be registered can be registered up to the maximum registration number. In the unlocking operation, the locked state can be released, when one of the user keys is matched with the input key.

1.5 Function Block of Memory Card

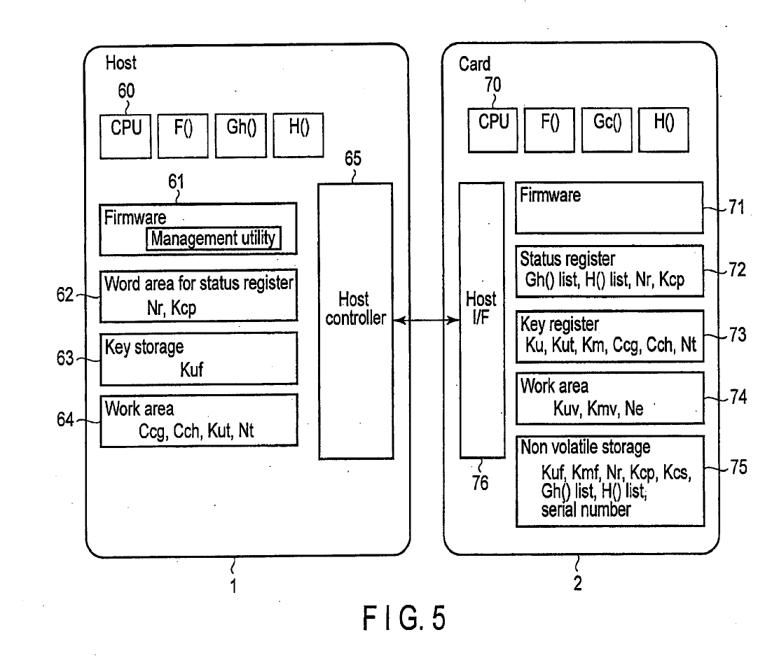

Next, a function block of the memory card 2 which is focused especially on the configuration operation will be described with reference to FIG. 5. FIG. 5 is a function block diagram of the memory system.

1.5.1 Symbol Definition

Prior to the explanation of the function block, symbols for use in the present description are defined as follows.

(i) Definition of Usual Key Symbols
Ku (User Key): a key to be set by the user
Km (Master Key): a key set at shipping and having a high priority
Kcp (Card Public Key): a public key of a card RSA cipher
Kcs (Card Secret Key): a secret key of the card RSA cipher
Ccx (Cipher Code, x=g or h): a code indicating a cipher system and an algorithm for use
Nr: a random number

(ii) Type and Notation of Conversion Function
F( ): a cipher function for storage in the flash memory

Encode: Kuf=F(Ku, “Enc”)

Decode: Ku=F(Kuf, “Dec”)

It is to be noted that the conversion function F( ) also includes a case where the conversion is not performed (Kuf=Ku). The host apparatus and the card use a common notation, but the function itself does not have to be the same, and an individual function may be used.
Gh( ), Gc( ): a cipher function using an RSA cipher and a decode function

Kcp host encode: Kut=Gh(Kcp, Ku)

Kcs card decode: Ku=Gc(Kcs, Kut)

When there are plural Gh( ) and Gc( ) functions, types of Gh( ) and Gc( ) for use are shown by Ccg.
H( ): a conversion function for the registration of the user key

When a long key is converted to a short key by use of a compressive function, the comparison of keys can be facilitated.

Nt=H(Nr, Ku)

(iii) Type and Notation of Key
Kx or Kxy: a notation of a key

x=m: the master key, x=u: the user key

y=f: Ciphered by F( ) so that the key is held in the flash memory

y=t: a time of transmission/reception between the host and the card, y=v: a time of verification

Types of the master keys: Km, and Kmf

Types of the user keys: Ku, Kut, Kuf, and Kuv
Nx: a notation of the random number for use in challenge

x=r: a random number seed

x=t: a random number in which the key for use at the transmission/reception between the host and the card is buried

x=e: an expected value calculated by the card

Types of challenge numbers: Nr, Nt, and Ne

1.5.2 Regarding Host Apparatus 1

As shown in FIG. 5, the host apparatus 1 includes a CPU 60, conversion functions Gc( ), H( ) and F( ) a firmware 61, a register 62, a key storage area 63, a work memory 64, and a host controller 65.

The CPU 60 controls the whole operation of the host apparatus 1, and corresponds to the MPU 11 described with reference to FIG. 1. Moreover, the CPU 60 can access to the conversion functions Gh( ) and H( ), the firmware 61, the register 62, the key storage area 63, the work memory 64 and the host controller 65.

The conversion function Gh( ) is a cipher function for use during the registration of the user key. For the conversion function Gh( ), for example, an RSA cipher system is used in which the user key is ciphered by the public key read from the memory card 2. The conversion function Gh( ) may be software (e.g., stored in the ROM 14 described with reference to FIG. 1), but may be hardware for achieving a high speed. When a plural conversion functions Gh( ) is prepared, the conversion function is selected from a Gh( ) list included in status information of the memory card 2 (held in a register 72 of FIG. 5). That is, the Gh( ) list is a list of the conversion functions, which are supported by the memory card 2, for the registration of the user key. The host apparatus 1 selects the function supported by the host apparatus 1 from this Gh( ) list. A code Ccg indicating the selected function is held in the work memory 64. When there is only one type of Gh( ), it is not essential to use the Gh( ) list.

The conversion function H( ) is a cipher function for use during authentication of the user key. The user key is ciphered utilizing the conversion function H( ) by use of the random number read from the memory card 2. The conversion function H( ) may also be software (e.g., stored in the ROM 14 described with reference to FIG. 1), but is preferably hardware from the viewpoint of the achievement of the high speed. The conversion function H( ) is selected from an H( ) list of the status information of the memory card 2 (held in the register 72 of FIG. 5). That is, the H( ) list is a list of the conversion functions, which are supported by the memory card 2, for the authentication of the user key. The host apparatus 1 selects the function supported by the host apparatus 1 from this H( ) list. A code Cch indicating the selected function is held in the work memory 64. When there is only one type of H( ), it is not essential to use the H( ) list. As the conversion function H( ), a hash function can be used, and when the long key is converted to the short key by this function, the comparison of the keys can be facilitated. An example of H( ) is MD5 (Nr∥Ku). H( ) may have an inverse function, but in the present embodiment, H( ) indicates an example where the function does not have the inverse function (for F( ) the inverse function is defined by “Dec” and “Enc”).

The host controller 65 performs interface processing between the host apparatus 1 and the memory card 2. The host controller 65 corresponds to the host interface circuit 12 in FIG. 1. The host controller 65 issues various commands to the card 2, and controls the execution of the command in accordance with a response of the card 2.

The CPU 60 operatively executes the firmware 61, and controls the operation of the host apparatus 1. Moreover, the firmware 61 includes the above-mentioned management utility. The management utility prepares the user key on the basis of the random number or the information inherent in the host apparatus 1 without accepting, for example, the input of the password from the user. As the method of preparing the user key, various known methods can be used, and examples of the information inherent in the host apparatus 1 include random number generation, and a manufacturing number or serial number of the host apparatus 1. Alternatively, the user key may be prepared on the basis of the results of calculation using the information inherent in the host apparatus 1 and information inherent in the memory card 2. The firmware 61 is stored, for example, in the ROM 14 of FIG. 1.

The register 62 holds the status information read from the memory card 2. Examples of the status information include a random number Nr and a cipher key Kcp of the RSA cipher. As the register 62, for example, a volatile memory can be used, and the register corresponds to, for example, the RAM 13 in FIG. 1.

In the key storage area 63, a user key Ku prepared by the management utility or an accepted user key Ku input from the user is ciphered by F( ), and held as Kuf. The key storage area 63 corresponds to, for example, a nonvolatile semiconductor memory (which may be referred to as “host memory) which is not shown in FIG. 1. Information in the key storage area 63 is managed so that the information cannot easily be read from the outside.

The work memory 64 is used as a work area when the CPU 60 executes various pieces of processing such as processing concerning the user key, and it corresponds to, for example, the RAM 13 in FIG. 1. Furthermore, the work memory 64 holds the codes Ccg and Cch for use, or keys Kut, Nt and the like calculated by the CPU 60.

1.5.3 Memory Card 2

A CPU 70 controls the whole operation of the memory card 2, and corresponds to the MPU 42 described with reference to FIG. 1. Moreover, the CPU 70 can access to the conversion functions Gc( ), H( ) and F( ), firmware 71, registers 72 and 73, a work memory 74 and a nonvolatile memory 75.

The conversion function Gc( ) is a cipher function for use during the registration of the user key. Furthermore, for the conversion function Gc( ), for example, an RSA cipher system is used in which the user key is decoded by the secret key. The conversion function Gc( ) may be software (e.g., stored in the ROM 14 described with reference to FIG. 1), but may be hardware for achieving the high speed. The conversion function Gc( ) corresponds to the conversion function Gh( ) of the host apparatus 1. Additionally, the conversion function Gc( ) is any function included in the Gh( ) list as a list of the functions, which are supported by the memory card 2, for the registration of the user key.

The conversion function H( ) is a cipher function for use during the authentication of the user key. The user key is ciphered utilizing the conversion function H( ) by use of the random number read from the nonvolatile memory 75. The conversion function H( ) may also be software (e.g., stored in the ROM 14 described with reference to FIG. 1), but is preferably hardware from the viewpoint of the achievement of the high speed. The conversion function H( ) corresponds to the conversion function H( ) of the host apparatus 1. Additionally, the conversion function H( ) is any function included in the H( ) list as a list of the functions, which are supported by the memory card 2, for the authentication of the user key. As described above, in the conversion function H( ), a hash function can be used, whereby a key length can be shortened and the comparison can be facilitated.

A host interface 76 performs interface processing between the memory card 2 and the host apparatus 1. The host interface 76 corresponds to the host interface 41 in FIG. 1.

The firmware 71 is executed by the CPU 70. Moreover, the CPU 70 operatively executes the firmware 71, and controls the operation of the memory card 2. The firmware 71 is stored, for example, in the ROM 43 of FIG. 1, and cannot be seen or accessed from the host apparatus 1.

The register 72 can hold the status information indicating the state of the memory card 2. The host apparatus 1 can read the status information from the register 72 by use of the control command, and can grasp the state of the memory card 2. The random number Nr is updated to a different value, for example, by the CPU 70, every time the unlocking operation, or an erasing operation or a checking operation of the user key is performed. The secret key Kcs is not shown to the host apparatus, and hence the key is not held in the register 72.

The register 73 is a register which is writable by the host apparatus 1. Furthermore, the register 73 holds various pieces of key information (e.g., Ku, Kut, Km, Ccg, Cch, Nt, etc.) transmitted from the host apparatus 1.

When the registers 72 and 73 are hardware, these registers correspond to, for example, the register 46 in FIG. 1, but a virtual register can be made of the firmware 71 on the RAM 44. As to an initial value of a status, when the memory card 2 is initialized, the CPU 70 copies required information from the nonvolatile memory 75 to the register 72. Examples of the information include the Gh( ) list, the H( ) list, the random number Nr, and the public key Kcp.

The work memory 74 is used as a work area when the CPU 70 executes various pieces of processing such as the processing concerning the user key, and corresponds to, for example, the RAM 44 in FIG. 1. Furthermore, the work memory 74 holds calculated comparison values Kuv and Kmv, an expected value Ne, and the like. The work memory 74 cannot directly be accessed by the host apparatus 1.

The nonvolatile memory 75 corresponds to the NAND flash memory 31 in FIG. 1. The host apparatus 1 cannot directly access the nonvolatile memory 75, and accesses the memory via the host interface 76 or the CPU 70 (the controller 32 in FIG. 1). The nonvolatile memory 75 holds various pieces of necessary information (e.g., Kuf, Kmf, Nr, Kcp, Kcs, the Gh( ) list, the H( ) list, etc.) in the nonvolatile manner. These pieces of information are held in the area which cannot be seen from the host apparatus 1, and the information cannot directly be accessed by the host apparatus 1. That is, these pieces of information are held in an area which is not shown in FIG. 2. Furthermore, these pieces of information basically have fixed values. However, as described above, the random number seed Nr is updated by the CPU 70. In this case, the CPU 70 updates Nr so that the updated value does not become the same as a past value. Additionally, the nonvolatile memory 75 holds the inherent information of the memory card 2, for example, the serial number in the nonvolatile manner. The serial number can be read by the host apparatus 1.

2. Operation of Memory System

Next, an operation of the memory system of the above-mentioned constitution will be described. Hereinafter, the configuration operation and the locking/unlocking operation will successively be described.

2.1 Operation of Memory Card Immediately after Powered On

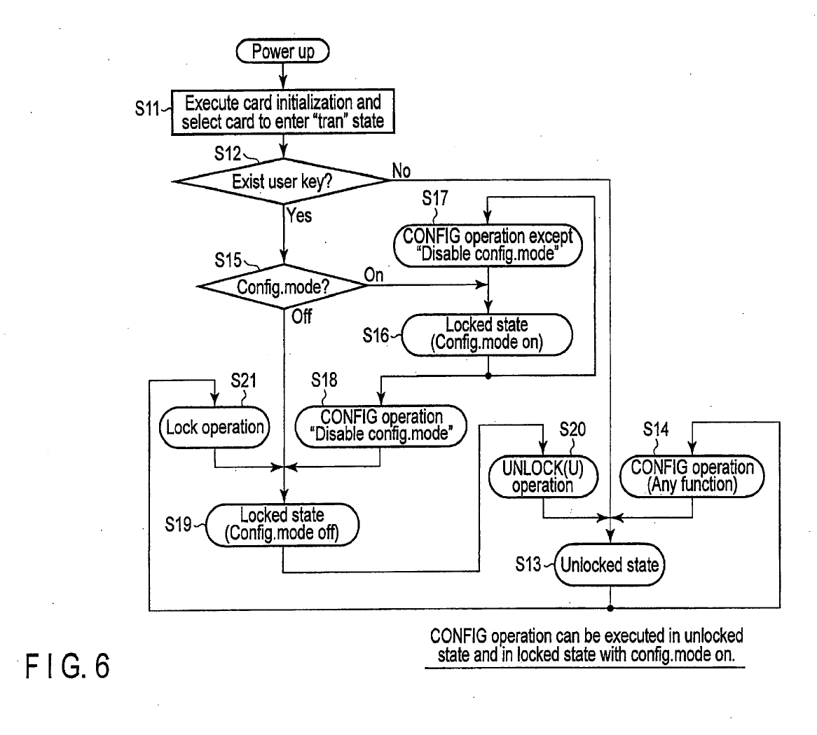

First, there will be described an operation immediately after the memory card 2 is connected to the host apparatus 1 and the power is turned on, with reference to FIG. 6. FIG. 6 is a flowchart showing the operation of the memory card 2. It is to be noted that the processing in FIG. 6 is executed mainly by the CPU 70.

When the memory card 2 is connected to the host apparatus 1, the host apparatus 1 supplies the power to the memory card 2. Then, the CPU 60 of the host apparatus 1 issues an initialization command, to initialize the memory card 2. In response to this command, the CPU 70 of the memory card 2 executes an initializing operation (step S11). The initialization is processing to obtain a state where the memory space of the memory card 2 is accessible from the host apparatus 1, and more specifically processing to obtain a state where the reading command can be accepted from the host apparatus 1. This state will be called a transfer state (the “tran” state). Moreover, in the process of the initialization processing, the required information is read from the nonvolatile memory 75 to the register 73. Further in the process of the initialization processing, a transfer mode of a bus between the host apparatus 1 and the memory card 2 is selected. For example, transfer modes are prepared in the bus, and a transfer speed of the data varies in accordance with the transfer mode. Any one of these transfer modes is selected in the initialization processing.

The CPU 70 of the memory card 2 which has changed to the transfer state determines whether or not at least one user key is set in the memory card 2 (step S12). This determination is executable with reference to the nonvolatile memory 75 by the CPU 70. More specifically, the CPU 70 can perform the determination by checking whether or not the ciphered user key Kuf is held in the nonvolatile memory 75. Alternatively, information indicating whether the user key is set may be held as a part of the status information in the register 72.

When the user key is not set (the step S12, NO), the CPU 70 brings the memory card into the unlocked state (the step S13). That is, the host apparatus 1 can execute the reading access and the writing access to both the file system management area 50 and the file system data area 51 of the memory card.

In the unlocked state, all the configuration operations are executable (step S14). The registration, erasing, checking and the like of the user key can be performed. Moreover, in the memory card 2, the configuration mode is in off-state turned off at the default setting. Therefore, for example, when the user key is set in another host apparatus 1 (a second host apparatus 1), the configuration operation is executed to set the configuration mode to the on-state. Next, a flow of the processing in this case will be described.

When the memory card 2 in which the user key is set and set the configuration mode to the on-state in the step S14 by the first host apparatus 1 is connected to the second host apparatus 1, the CPU 70 of the memory card 2 recognizes that a certain user key is registered on the basis of the fact that the ciphered user key Kuf is held in the nonvolatile memory 75, or the like (the step S12, YES).

Then, the CPU 70 determines whether or not the configuration mode is in the on-state (step S15). This determination is executable with reference to the status information set to, for example, the register 72 in the memory card 2.

When the configuration mode is in the on-state (the step S15, ON), the memory card 2 is in the locked state, and the configuration operation is in an executable state (step S16). The second host apparatus 1 sets the user key (step S17). Then, as long as the configuration mode is not turned off, it remains in the step S16.

When the second host apparatus 1 turns off the configuration mode in the step S16 (step S18), the execution of the configuration operation is prohibited, while the memory card 2 maintains the locked state (step S19).

In the step S19, the host apparatus can execute the unlocking operation (step S20). In the unlocking operation, when the memory card 2 is authenticated by the user key registered by the second host apparatus, the memory card 2 changes to the unlocked state (the step S13). In consequence, the host apparatus 1 can access the file system data area 51 of the memory card 2. Whether to prohibit the reading of the data from the file system management area 50 depends on a mounting condition.

Moreover, when the host apparatus 1 executes the locking operation to the memory card 2 in the unlocked state, the memory card 2 can be changed to the locked state. At this time, the host apparatus 1 determines whether or not the user key is matched, and when matched, the host apparatus 1 sets the memory card to the locked state. Alternatively, the host apparatus 1 may only confirm that the user key is registered, and when any user key is registered, the host apparatus 1 may set the memory card to the locked state.

2.2 Configuration Operation

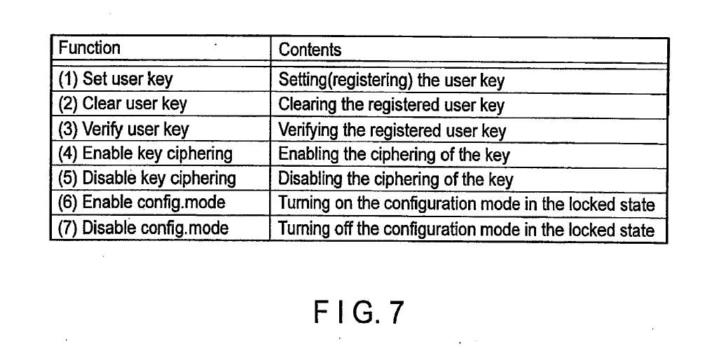

The details of the above configuration operation will be described with reference to FIG. 7. FIG. 7 is a table showing contents of the configuration operation.

The configuration operation includes the following seven functions.

(1) “Set User Key”: a function of setting (registering) the user key

(2) “Clear User Key”: a function of clearing the registered user key

(3) “Verify User Key”: a function of verifying the registered user key

(4) “Enable Key Ciphering”: a function of enabling the ciphering of the key

(5) “Disable Key Ciphering”: a function of disabling the ciphering of the key

(6) “Enable Config. Mode”: a function for turning on the configuration mode in the locked state

(7) “Disable Config. Mode”: a function for turning off the configuration mode in the locked state

Here, the seven basic functions are exemplified, but a configuration function can be expanded. Therefore, for example, when the unlocked state is changed by a specific user key, it is possible to add the setting of performing a special operation in which the reading of the memory space is only allowed, and the writing is not allowed. There is no special restriction on the type of the function.

Hereinafter, the details of the configuration operation will successively be described.

2.3 “Set User Key” Function

The “Set User Key” function will be described. As described above, an unique user key can be set as the user key for each host apparatus. Then, after the user keys are set, the memory card can be set to a usable state (the unlocked state) by inputting any registered user key. The use of the long key considerably lowers the probability that the same key is set for different host apparatuses.

2.3.1 Operation of Host Apparatus 1

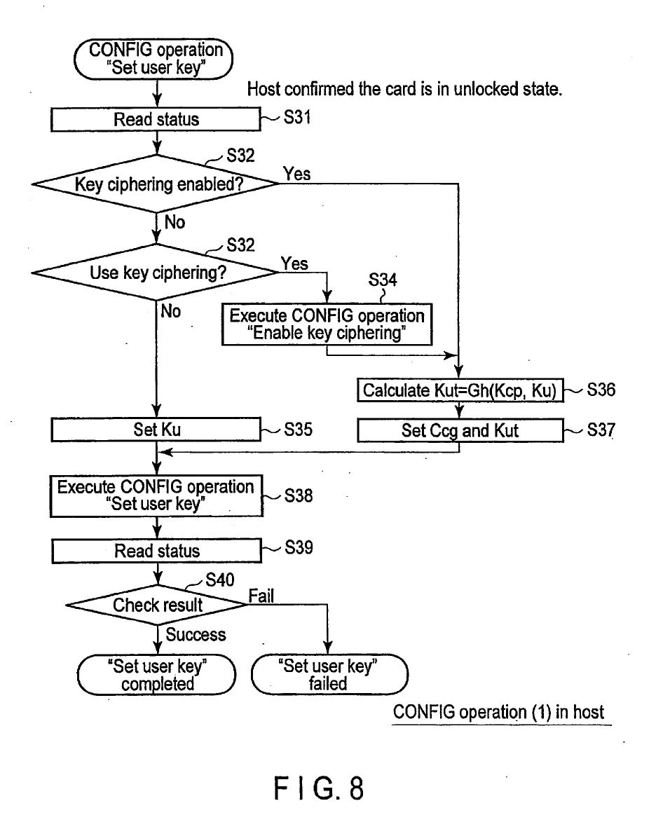

First, the operation of the host apparatus 1 during the execution of the “Set User Key” function will be described with reference to FIG. 8. FIG. 8 is a flowchart showing a flow of the processing of the host apparatus 1, and this processing is performed, for example, mainly by the CPU 60.

As shown in the drawing, the CPU 60 of the host apparatus 1 issues the reading command for the register 72 of the memory card 2, and reads the status information of the memory card 2 (step S31). Then, the CPU 60 checks whether the key ciphering is enabled or disabled (step S32). The information on whether the key ciphering is enabled or disabled is read as a part of the status information in the step S31. Moreover, the enabling/disabling of the key ciphering can be set in a state where no user keys are registered, and the enabling/disabling cannot be changed once the user key is registered. However, when all the user keys are cleared, the enabling/disabling can be set again. It is to be noted that the key ciphering is disabled as the default.

When the key ciphering is used (step S33, YES), the host apparatus 1 executes the “Enable Key Ciphering” function, to enable the key ciphering (step S34).

When the key ciphering is not used (the step S33, NO), the host apparatus 1 transmits a plaintext of the user key Ku as it is, from the host controller 65 to the memory card 2 (step S35). This user key Ku may automatically be prepared by using of the management utility by the CPU 60, or the input of the user key from the user may be accepted. The transmitted user key Ku is ciphered by F( ) and held in the register 73 of the memory card 2 (Kuf).

When the key ciphering is used (the step S32, YES, and the step S34), the conversion function Gh( ) for use is determined on the basis of the status information read in the step S31, and the code Ccg corresponding to the function is determined. From Gc( ) and Gh( ) pairs supported by the card, one pair which is usable by the host apparatus is selected. Then, the user key Ku is ciphered by using the conversion function Gh( ) (step S36). The ciphered user key Kut is calculated in accordance with Kut=Gh(Kcp, Ku).

Then, the host apparatus 1 transmits the determined code Ccg and the ciphered user key Kut from the host controller 65 to the memory card 2 (step S37). These pieces of information are held in the register 73 of the memory card 2.

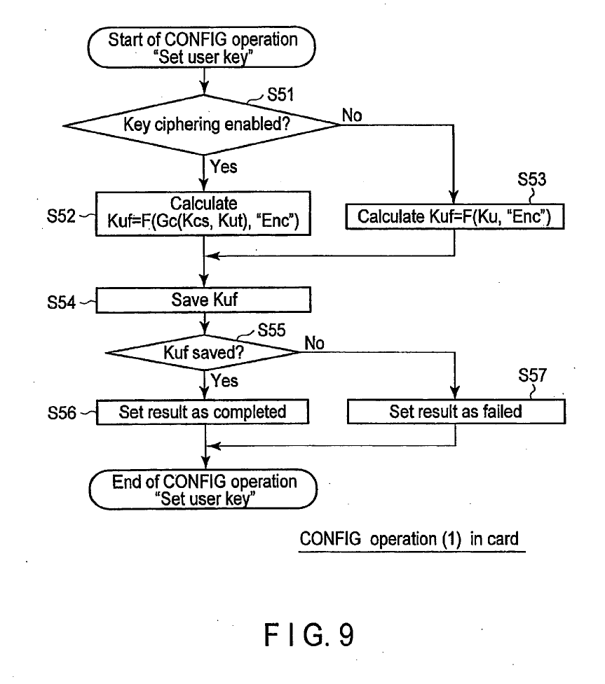

Afterward, the host apparatus 1 issues an execution command of the “Set User Key” function to the memory card 2. In response to this command, the “Set User Key” function is executed in the memory card 2 (step S38). The processing in the memory card 2 will be described later with reference to FIG. 9.

Afterward, when a busy state of the memory card 2 is cleared, the host apparatus 1 recognizes that the processing in the memory card 2 is completed. The busy state is a state where the memory card 2 cannot accept any commands. When the busy state is cleared to change to a ready state, the memory card 2 can accept the command. This information is sent as a ready/busy signal (or packet information to be sent from the card to the host apparatus) from the memory card 2 to the host apparatus 1.

Then, the host apparatus 1 reads the status information, for example, from the register 72 of the memory card 2 (step S39). Then, the host apparatus 1 checks the execution result in the memory card 2 (step S40). As a result, when the configuration operation in the memory card 2 is successful (the step S40, Success), the host apparatus 1 recognizes that the “Set User Key” function is normally completed. On the other hand, when the configuration operation fails (the step S40, Fail), the host apparatus 1 recognizes that the “Set User Key” function has failed.

2.3.2 Operation of Memory Card 2

Next, the operation of the memory card 2 in the above step S38 will be described with reference to FIG. 9. FIG. 9 is a flowchart showing the processing of the memory card.

As shown in the drawing, when the execution command of the “Set User Key” function is received from the host apparatus 1, for example, the CPU 70 of the memory card 2 judges whether or not the key ciphering is enabled (step S51). When the key ciphering is enabled (the step S51, YES), the CPU 70 reads the information set to the register 73 to process the information. The conversion function Gc( ) corresponding to the code Ccg received from the host apparatus 1 is determined, and further the ciphered user key Kuf to be stored in the nonvolatile memory 75 is calculated from the received ciphered user key Kut by use of the conversion function F( ) (step S52). More specifically, the ciphered user key Kuf is calculated in accordance with Kuf=F(Gc(Kcs, Kut), “Enc”). Kut is decoded to Ku by Kcs which is the secret key of the RSA cipher Gc. Therefore, Gc(Kcs, Kut)=Ku. When the key is stored in the flash memory, the key is set so that the key cannot be seen. Kuf obtained by ciphering Ku by the conversion function F( ) is calculated.

On the other hand, when the key ciphering is not enabled (the step S51, NO), the CPU 70 calculates Kuf by ciphering the received plaintext user key Ku with the conversion function F( ) (step S53). More specifically, the ciphered user key Kuf is calculated in accordance with Kuf=F(Ku, “Enc”).

After the step S52 or S53, the CPU 70 writes the calculated ciphered user key Kuf into the nonvolatile memory 75 (step S54). Then, the CPU 70 checks whether or not the writing of the ciphered user key Kuf into the nonvolatile memory 75 is successful (step S55).

When the writing is successful (the step S55, YES), the CPU 70 stores the status information indicating that the configuration operation is successful, for example, in the register 72 (step S56). On the other hand, when the writing fails (the step S55, NO), the CPU 70 stores, in the register 72, the status information indicating that the configuration operation has failed (step S57).

Afterward, the CPU 70 clears the busy state, to end the configuration operation.

2.3.3 “Set User Key” Sequence

Next, a sequence during the execution of the above “Set User Key” function will be described. In the present description, the above descriptions of 2.3.1 and 2.3.2 are simplified and summarized.

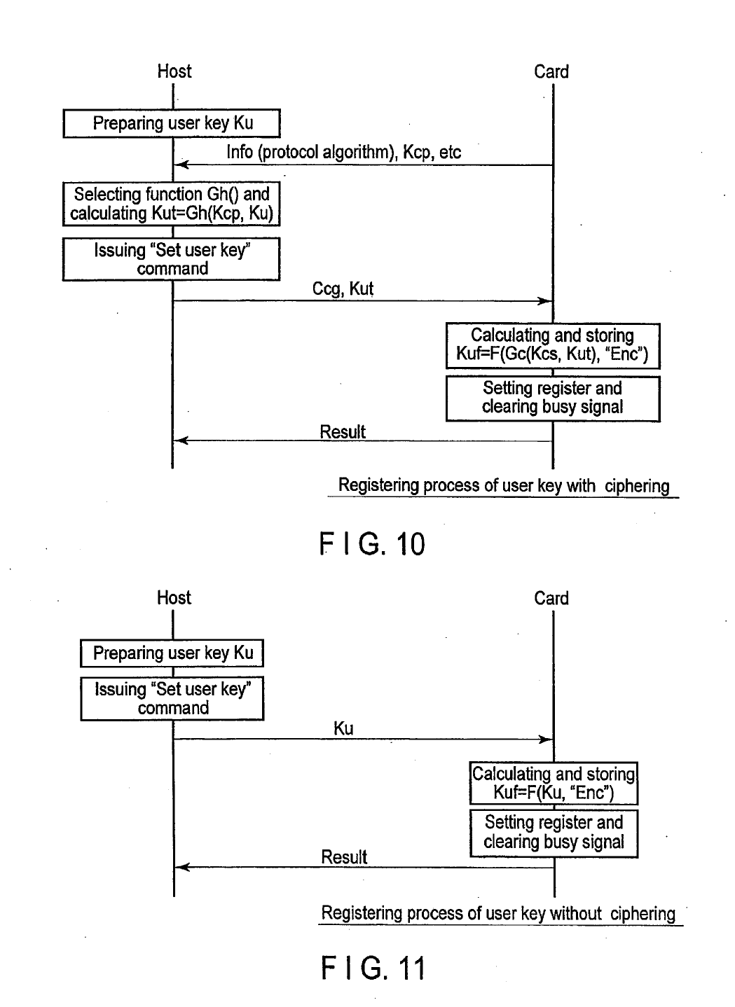

FIG. 10 shows a “Set User Key” sequence of a case where the key ciphering is enabled.

As shown in the drawing, the host apparatus 1 first determines the user key Ku. As described above, the user key Ku is prepared by the management utility, or the input of the user key from the user is accepted. Then, the host apparatus 1 ciphers the user key Ku by the conversion function F( ), to prepare the ciphered user key Kuf, and this key is held in the key storage area 63. It is to be noted that the host apparatus 1 reads the ciphered user key from the key storage area 63, and decodes this key by the conversion function F( ), whereby the plaintext user key Ku can be obtained.

Then, the host apparatus 1 reads card information (a protocol/algorithm of the ciphering (the Gh( ) list) or the public key Kcp) from the memory card 2. Then, the host apparatus 1 selects the usable conversion function Gh( ) from the Gh( ) list, and ciphers the user key Ku to calculate the ciphered user key Kut (=Gh(Kcp, Ku)). Furthermore, the host apparatus 1 transmits, to the memory card 2, the code Ccg indicating the selected Gh( ) and the ciphered user key Kuf (sets the information in the register 73), and the host apparatus instructs the memory card 2 to register the prepared user key Ku.

The memory card 2 selects the conversion function Gc( ) on the basis of the code Ccg received in the register 73, and deciphers (decodes) the ciphered user key Kut by the corresponding secret key Kcs, to obtain the plaintext user key Ku. Then, the memory card 2 prepares the ciphered user key Kuf (=F(Ku, “Enc”) by use of the key conversion function F( ), and stores the key in the nonvolatile memory 75. Then, the memory card 2 notifies the host apparatus 1 of the registration completion or registration failure.

By the above, the user key Ku is registered between the host apparatus 1 and the memory card 2. It is to be noted that as the cipher function Gh, for example, the ciphering of RSA2048 is used, and as Gc, for example, the decoding of RSA2048 is used.

FIG. 11 shows the “Set User key” sequence of a case where the key ciphering is disabled. The status information indicating that the ciphering is disabled is present in the status register 72, but it is assumed that the host apparatus 1 already reads this register, and hence the information is omitted from FIG. 11.

As shown in the drawing, the host apparatus 1 first determines the user key Ku. As described above, the user key Ku is prepared by the management utility, or the input of the user key from the user is accepted. Then, the host apparatus 1 ciphers the user key Ku by the conversion function F( ), to prepare the ciphered user key Kuf, and this key is held in the key storage area 63.

Then, the host apparatus 1 transmits the plaintext user key Ku to the memory card 2, and instructs the memory card 2 to register the prepared user key Ku.

The memory card 2 prepares the ciphered user key Kuf (=F(Ku, “Enc”)) by use of the key conversion function F( ) and stores the key in the nonvolatile memory 75. Then, the memory card 2 notifies the host apparatus 1 of the registration completion or registration failure.

2.4 “Clear/Verify User Key”, “Enable/Disable Key Ciphering”, and “Enable/Disable Config. Mode” Functions

Next, there will be described the “Clear User Key” function, the “Verify User Key” function, the “Enable Key Ciphering” function, the “Disable Key Ciphering” function, the “Enable Key Config. Mode” function and the “Disable Config. Mode” function. The “Clear User Key” function is the function for clearing the registered user key from the memory card 2. The “Verify User Key” function is the function for verifying whether the registered user key is valid or not (correct or not). The “Enable Key Ciphering” and “Disable Key Ciphering” functions are the functions for enabling and disabling the key ciphering, respectively. The “Enable Config. Mode” and “Disable Config. Mode” functions are functions for turning on and off the configuration mode, respectively.

2.4.1 Operation of Host Apparatus 1

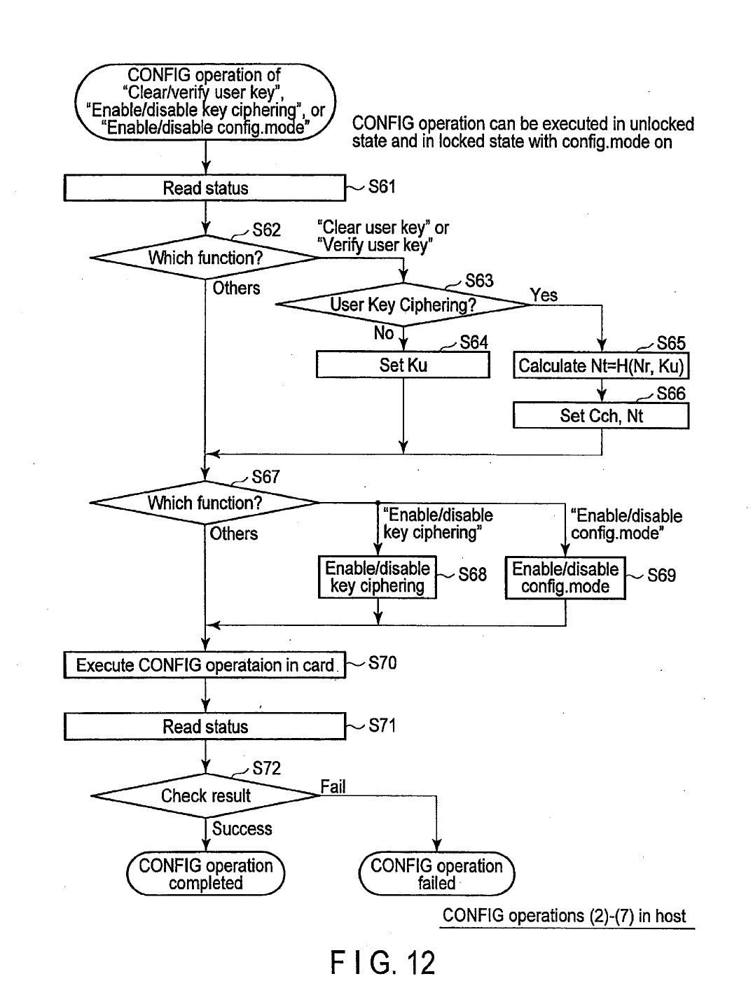

The operation of the host apparatus 1 during the execution of the above “Clear/Verify User Key”, “Enable/Disable Key Ciphering” or “Enable/Disable Config. Mode” function will be described with reference to FIG. 12. FIG. 12 is a flowchart showing a flow of the processing of the host apparatus 1, and this processing is performed, for example, mainly by the CPU 60.

As shown in the drawing, the CPU 60 of the host apparatus 1 issues the reading command for the register 72 of the memory card 2, and reads the status information of the memory card 2 (step S61). When the function to be executed is “Clear User Key” or “verify User Key” (step S62, “Clear User Key” or “Verify User Key”), the processing proceeds to the processing of step S63. Then, the CPU 60 checks whether the key ciphering is enabled or disabled (the step S63). When the key ciphering is disabled (the step S63, NO), the host apparatus 1 transmits the plaintext user key Ku as it is, from the host controller 65 to the memory card 2 (step S64). The transmitted user key Ku is held in the register 73 of the memory card 2.

When the key ciphering is enabled (the step S63, NO), the host apparatus determines the conversion function H( ) for use on the basis of the status information (the H( ) list) read in the step S61, and determines the code Cch corresponding to the determined function. Then, the host apparatus ciphers the user key Ku by use of the conversion function H( ), to calculate the challenge number Nt (step S65). The challenge number Nt is calculated in accordance with Nt=H(Nr, Ku). The random number Nr is also information read as the status information from the memory card 2. Then, the host apparatus 1 transmits the determined code Cch and the challenge number Nt from the host controller 65 to the memory card 2 (step S66). These pieces of information are held in the register 73 of the memory card 2.

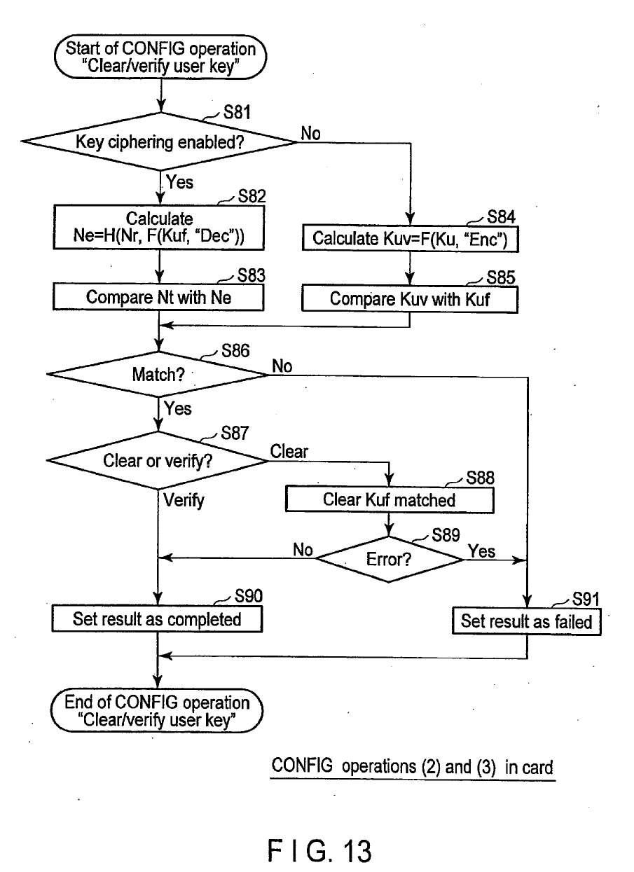

Afterward, the host apparatus 1 issues the execution command of the “Clear User Key” function or the “Verify User Key” function to the memory card 2. In response to this command, in the memory card 2, the “Clear User Key” function or the “Verify User Key” function is executed (step S70). The processing in the memory card 2 will be described later with reference to FIG. 13.

When the busy state of the memory card 2 is cleared, the host apparatus 1 recognizes that the processing in the memory card 2 is completed. Then, the host apparatus 1 reads the status information, for example, from the register 72 of the memory card 2 (step S71). Then, the host apparatus 1 checks the execution result in the memory card 2 (step S72). In consequence, when the configuration operation in the memory card 2 is successful (the step S72, Success), the host apparatus 1 recognizes that “Clear User Key” or “Verify User Key” is normally completed. That is, when the “Clear User Key” function is executed, the host apparatus recognizes that the user key Ku transmitted in the step S64 is cleared. On the other hand, when the “Verify User Key” function is executed, the host apparatus recognizes that the user key Ku transmitted in the step S64 or the step S66 is the correct user key.

On the other hand, when the configuration operation fails in the step S70 (the step S72, Fail), the host apparatus 1 recognizes that “Clear User Key” or “Verify User Key” has failed. That is, when the “Clear User Key” function is executed, the host apparatus recognizes that the user key Ku transmitted in the step S64 is not cleared. On the other hand, when the “Verify User Key” function is executed, the host apparatus recognizes that the user key Ku transmitted in the step S64 or the step S66 is the wrong user key.

When the function to be executed is “Enable Key Ciphering”, “Disable Key Ciphering”, “Enable Config. Mode” or “Disable Config. Mode” (the step S62, Others), the user key Ku is not required, and hence the processing of the steps S64 to S66 is omitted. Then, when the “Enable Key Ciphering” function or the “Disable Key Ciphering” function is executed, the CPU 60 issues an enabling command or a disabling command of the key ciphering, and transmits the command to the memory card 2 (step S68). On the other hand, when the “Enable Config. Mode” function or the “Disable Config. Mode” function is executed, the CPU 60 issues the enabling command or the disabling command of Config. Mode, and transmits the command to the memory card 2 (step S69).

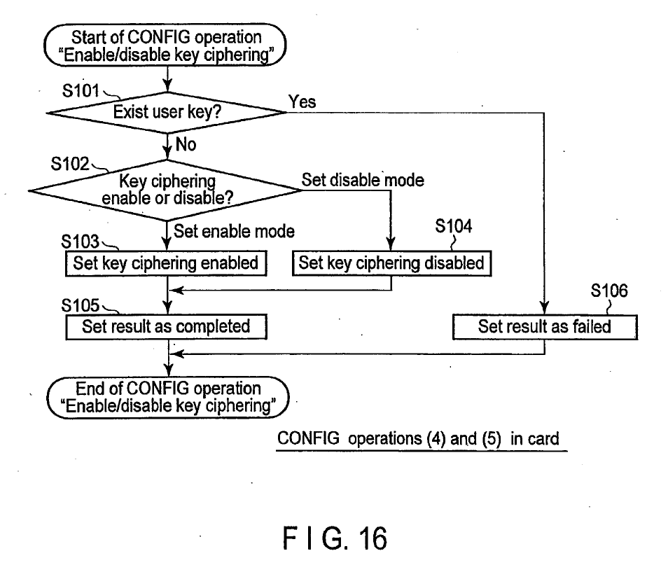

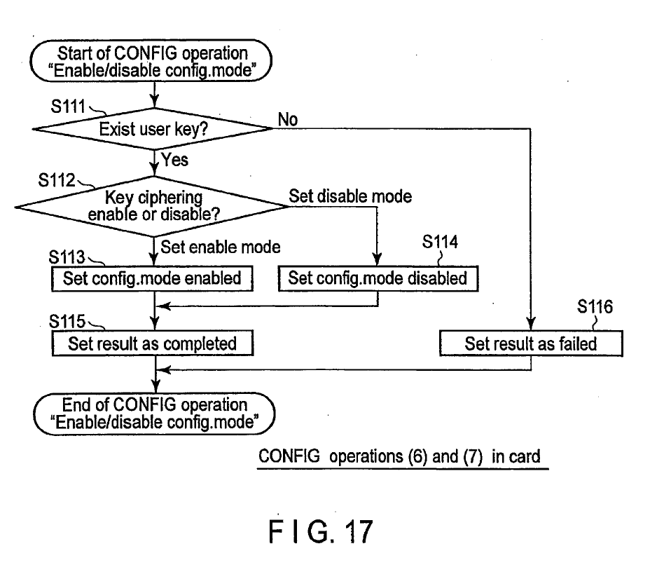

In response to these commands, in the memory card 2, the “Enable Key Ciphering”, “Disable Key Ciphering”, “Enable Config. Mode” or “Disable Config. Mode” operation is executed (the step S70). These details will be described later with reference to FIG. 16 and FIG. 17.

Afterward, the processing advances to the step S71. It is to be noted that as described above, the setting of the key ciphering is possible when the user key is not registered. Therefore, when the user key is registered and when the “Enable/Disable Key Ciphering” function is executed, the operation is notified as failure from the memory card 2 to the host apparatus 1.

2.4.2 Operation of Card of “Clear/Verify User Key”

Next, the operation of the card in the execution of the “Clear/Verify User Key” function in the above step S70 will be described with reference to FIG. 13. FIG. 13 is a flowchart showing the processing of the memory card 2.

As shown in the drawing, when the execution command of the “Clear/Verify User Key” function is received from the host apparatus 1, for example, the CPU 70 of the memory card 2 judges whether or not the key ciphering is enabled (step S81). When the key ciphering is enabled (the step S81, YES), the CPU 70 determines the conversion function H( ) corresponding to the code Cch received from the host apparatus 1, and further calculates the expected value Ne by use of the conversion function F( ), the ciphered user key Kuf held in the nonvolatile memory 75, and the random number Nr held as the status information in the register 72 (step S82). More specifically, the expected value Ne is calculated in accordance with Ne=H(Nr, F(Kuf, “Dec”)). Then, the CPU 70 compares the challenge number Nt received from the host apparatus 1 with the calculated expected value Ne (step S83).

When the key ciphering is not enabled (the step S81, NO), the CPU 70 ciphers the received plaintext user key Ku to calculate the comparison value Kuv by use of the conversion function F( ) (step S84). More specifically, the comparison value Kuv is calculated in accordance with Kuv=F(Ku, “Enc”). Then, the CPU 70 compares the ciphered user key Kuf read from the nonvolatile memory 75 with the calculated comparison value Kuv (step S85).

As a result of the comparison, when both the values are not matched (step S86, NO), the CPU 70 stores the status information indicating that the configuration operation has failed, for example, in the register 72 (step S91).

As a result of the comparison, when both the values are matched (the step S86, YES), the processing proceeds to the processing of step S87. That is, when the function to be executed is “Clear User Key” (the step S87, Clear), the ciphered user key Kuf matched in the step S83 or S85 is cleared from the nonvolatile memory 75 (step S88). When the clearing fails (step S89, YES), the processing proceeds to the step S91. When the clearing is successful (the step S89, NO), the CPU 70 stores, in the register 72, the status information indicating that the configuration operation is successful (step S90). When the function to be executed is “Verify User Key” (the step S87, Verify), the processing proceeds to the step S90.

Afterward, the CPU 70 clears the busy state, to end the configuration operation.

2.4.3 “Clear User Key” Sequence

Next, a sequence during the execution of the above “Clear User Key” function will be described. In the present description, the description of the “Clear User Key” function in the above 2.4.1 and 2.4.2 is simplified and summarized.

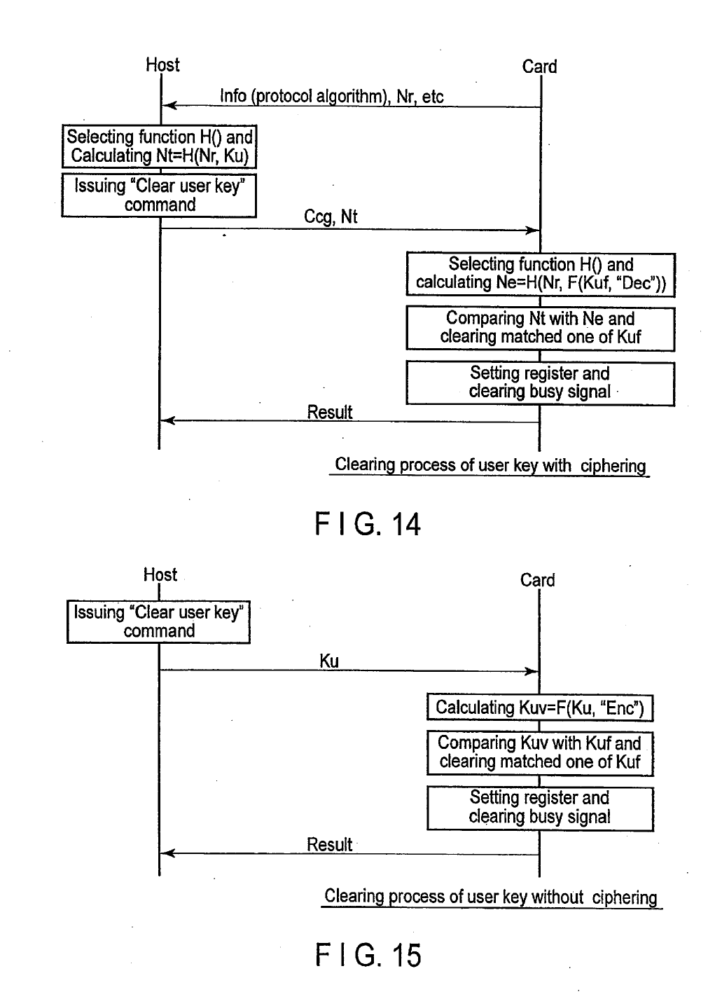

FIG. 14 shows the “Clear User Key” sequence of the case where the key ciphering is enabled.

As shown in the drawing, the host apparatus 1 first reads the card information (the protocol/algorithm of the ciphering (the H( ) list) or the random number Nr) from the memory card 2. Then, the host apparatus 1 selects the usable conversion function H( ) from the H( ) list, and ciphers the user key Ku by use of the random number Nr, to calculate the challenge number Nt (=H(Nr, Ku)). Here, the user key Ku to be ciphered is a user key desired to be cleared by the host apparatus 1. Furthermore, the host apparatus 1 transmits, to the memory card 2, the code Ccg indicating the selected H( ) and the calculated challenge number Nt, and instructs the memory card 2 to clear the user key Ku.

The memory card 2 reads the ciphered user key Kuf stored in the nonvolatile memory 75, and deciphers (decodes) the key by the conversion function F( ), to obtain the plaintext user key Ku. Then, the memory card 2 selects the conversion function H( ) on the basis of the received code Ccg, and calculates the expected value Ne (=H(Nr, F(Kuf, “Dec”))).

Then, the memory card 2 compares the challenge number Nt with the expected value Ne, and clears the corresponding ciphered user key Kuf from the nonvolatile memory 75. It is to be noted that when a plurality of ciphered user keys Kuf are stored in the nonvolatile memory 75, the expected value Ne is calculated for each key, and each expected value Ne is compared with the challenge number Nt. Then, the memory card clears the ciphered user key Kuf corresponding to the expected value matching the challenge number Nt, among the expected values Ne. Then, the memory card 2 notifies the host apparatus 1 of clearing completion or clearing failure of the user key.

By the above, the host apparatus 1 can clear the user key registered in the memory card 2.

FIG. 15 shows the “Clear User Key” sequence of the case where the key ciphering is disabled. The status information indicating that the ciphering is disabled is present in the register 72, but it is presumed that the host apparatus 1 has already read this register, and hence the status information is omitted from FIG. 15.

As shown in the drawing, the host apparatus 1 first transmits the plaintext user key Ku to the memory card 2, and instructs the memory card 2 to clear the user key Ku.

Then, the memory card 2 ciphers the received plaintext user key Ku by use of the conversion function F( ), to obtain the comparison value Kuv. Then, the memory card 2 compares the comparison value Kuv with the ciphered user key Kuf held in the nonvolatile memory 75, and clears the ciphered user key Kuf from the nonvolatile memory 75. Then, the memory card 2 notifies the host apparatus 1 of the clearing completion or the clearing failure of the user key.

It is to be noted that although not shown in the drawing, there is also a method in which Kuv is calculated in accordance with Kuv=F(Kuf, “Dec”), and compared with Ku.

It is to be noted that a sequence of the “Verify User Key” function corresponds to FIG. 14 and FIG. 15 from which the clearing processing of Kuf is omitted, and hence a detailed description is omitted.

2.4.4 Operation of Card of “Enable/Disable Key Ciphering”

Next, an operation of the card in the execution of the “Enable/Disable Key Ciphering” function in the step S70 of FIG. 12 will be described with reference to FIG. 16. FIG. 16 is a flowchart showing the processing of the memory card 2.

As shown in the drawing, when the execution command of the “Enable Key Ciphering” function or the “Disable Key Ciphering” function is received from the host apparatus 1, for example, the CPU 70 of the memory card 2 judges whether or not the user key is registered (step S101). When the user key has already been registered by any host apparatus 1 (the step S101, NO), the on/off of the key ciphering cannot be changed, and hence the processing proceeds to step S106 in which the execution of the function fails. That is, the CPU 70 stores the status information indicating that the configuration operation has failed, for example, in the register 72.

When the user key is not registered (the step S101, YES), the “Enable/Disable Key Ciphering” function is executable. When the execution command of the “Enable Key Ciphering” function is received (step S102, Set Enable mode), the CPU 70 enables the key ciphering, and stores information indicating the enabling as the status information in the register 72 (step S103). When the execution command of the “Disable Key Ciphering” function is received (the step S102, Set Disable mode), the CPU 70 disables the key ciphering, and stores information indicating the disabling as the status information in the register 72 (step S104).

Then, the CPU 70 stores the status information indicating that the configuration operation is successful, for example, in the register 72 (step S105). Afterward, the CPU 70 clears the busy state, to end the configuration operation.

2.4.5 Operation of Card of “Enable/Disable Config. Mode”

Next, an operation of the card in the execution of the “Enable/Disable Config. Mode” function in the step S70 of FIG. 12 will be described with reference to FIG. 17. FIG. 17 is a flowchart showing the processing of the memory card 2.

As shown in the drawing, when the execution command of the “Enable Config. Mode” or the “Disable Config. Mode” function is received from the host apparatus 1, for example, the CPU 70 of the memory card 2 judges whether or not the user key is registered (step S111). When the user key is not registered (the step S111, NO), the memory card 2 is in the unlocked state. Therefore, the host apparatus 1 can execute the configuration operation freely between the host apparatus and the memory card 2. Therefore, it is not necessary to set the configuration mode, and the processing proceeds to step S116 in which the execution of the function fails. That is, the CPU 70 stores the status information indicating that the configuration operation has failed, for example, in the register 72.

When the user key is registered (the step S111, YES), the “Enable/Disable Config. Mode” function is executable. When the execution command of the “Enable Config. Mode” function is received (step S112, Set Enable mode), the CPU 70 turns on the configuration mode (step S113). When the execution command of the “Disable Config. Mode” function is received (the step S112, Set Disable mode), the CPU 70 turns off the configuration mode (step S114).

After the step S113 or S114, the CPU 70 stores the status information indicating that the configuration operation is successful, for example, in the register 72 (step S115). Afterward, the CPU 70 clears the busy state, to end the configuration operation.

2.5 Unlocking Operation

Next, there will be described the unlocking operation for changing the memory card 2 in the locked state to the unlocked state in the memory system according to the present embodiment.

2.5.1 Type of Unlocking Operation

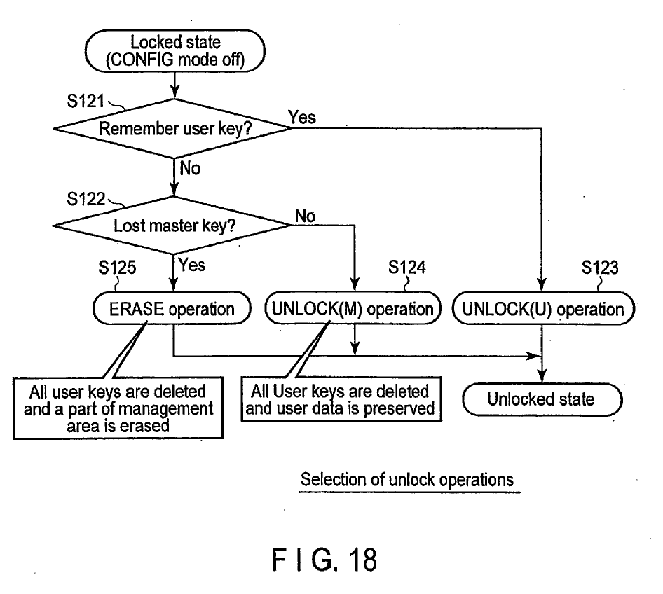

In the present embodiment, three types of unlocking operations are prepared. These unlocking operations will be described with reference to FIG. 18. FIG. 18 is a flowchart showing how to select the three types of the unlocking operation.

As shown in the drawing, when the user key is known (step S121, YES), the unlocking operation using the user key (an UNLOCK(U) operation) is executed (step S123). The case where the user key is known is a case where the user key Ku prepared by the management utility is correctly held in the host apparatus 1, a case where the correct user key input by the user is accepted, or the like.

Even when the user key is not remembered (the step S121, NO) and if the user knows the master key (step S122, NO), an unlocking operation using the master key (an UNLOCK(M) operation) is possible (step S124). That is, when the input of the correct master key is accepted from the user, the UNLOCK(M) operation is executed, and the memory card 2 can be changed to the unlocked state. However, when the UNLOCK(M) operation is executed, all the user keys registered in the memory card 2 are erased deleted differently from the UNLOCK(U) operation. However, the file system management area 50 and the file system data area 51 are not erased.

When the master key is lost (the step S122, YES), the memory card 2 can be changed from the locked state to the unlocked state by performing the erase operation (step S125). In this case, not only all the user keys but also at least a part of the information in the management area 50 is erased. When all the memory area 51 is erased, a considerably long time is required. Therefore, by a method in which a part of the user data area is erased or a method in which the controller 32 shuffles, for example, a table for converting the logical address to the physical address, the read data is changed to meaningless data, which shortens the time to disable the data.

2.5.2 Operation of Host Apparatus 1

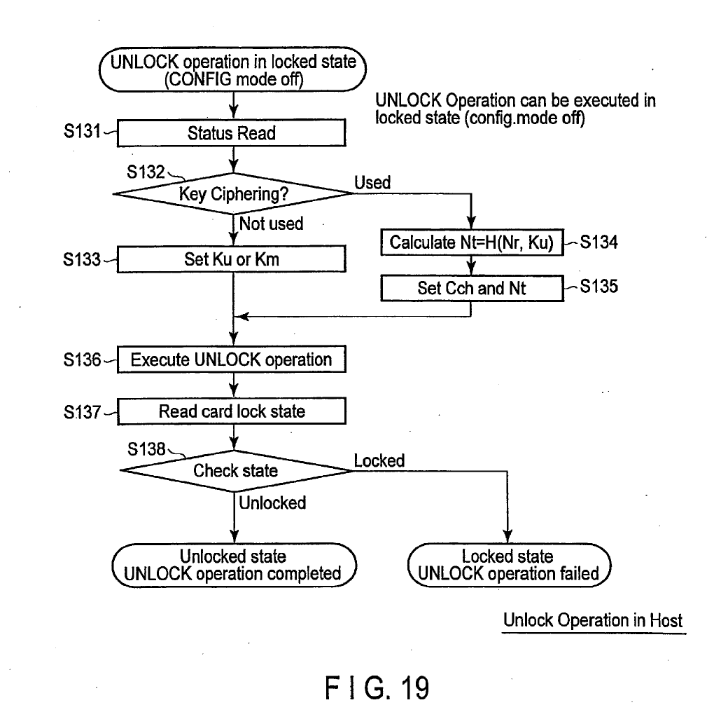

Next, details of the above unlocking operation will be described. FIG. 19 is a flowchart showing the processing of the host apparatus 1 in the unlocking operation using the user key or the master key (in the UNLOCK(U) or UNLOCK(M) operation). This unlocking operation is executable, when the memory card 2 is in the locked state and the configuration mode is off-state.

As shown in the drawing, the CPU 60 of the host apparatus 1 issues the reading command for the register 72 of the memory card 2, and reads the status information of the memory card 2 (step S131). The status information includes information indicating whether or not the key ciphering is enabled, information (the H( ) list) indicating the type of a usable cipher system, the public key (Kcp), and the random number (Nr) when the key ciphering is enabled. Then, the CPU 60 checks, on the basis of the read status information, whether the key ciphering is enabled or disabled (step S132).

When the key ciphering is not enabled (the step S132, Not Used), the host apparatus 1 transmits the plaintext of the user key Ku or the master key Km as it is, from the host controller 65 to the memory card 2 (step S133).

When the key ciphering is enabled (the step S132, Used), the CPU 60 of the host apparatus 1 determines the conversion function H( ) for use on the basis of the H( ) list read in the step S131, and determines the code Cch corresponding to the determined function. Then, the CPU ciphers the user key Ku with the random number Nr by use of the conversion function H( ), to calculate the challenge number Nt (step S134). That is, the challenge number Nt is calculated in accordance with Nt=H(Nr, Ku).

Then, the host apparatus 1 transmits the determined code Cch and the calculated challenge number Nt from the host controller 65 to the memory card 2 (the step S133). These pieces of information are held in the register 73 of the memory card 2.

It is to be noted that when one type of usable cipher system is determined, it is not necessary to identify the system, and hence the code Cch does not necessarily have to be sent. Moreover, even when the key ciphering is enabled, the ciphering of the master key does not have to be performed. In this case, it may be determined in advance that the master key is not ciphered, for example, between the host apparatus 1 and the memory card 2. In this case, there is the merit that the mounting lock/unlock function can easily be achieved.

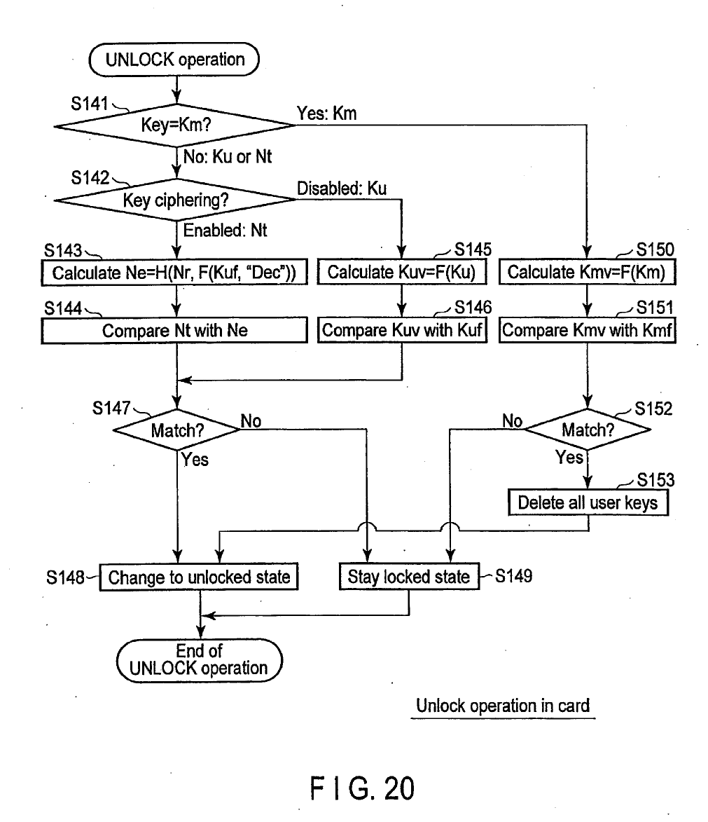

Afterward, the host apparatus 1 issues the execution command of the unlocking operation (UNLOCK(U), UNLOCK(M)) to the memory card 2. In response to this command, the unlocking operation is executed in the memory card 2 (step S136). The processing in the memory card 2 will be described later with reference to FIG. 20.

When the busy state of the memory card 2 is cleared, the host apparatus 1 recognizes that the processing in the memory card 2 is completed. Then, the host apparatus 1 reads the status information from the register 72 of the memory card 2 (step S137). When state information included in the status information indicates that the memory card 2 is in the unlocked state (step S138, Unlocked), the host apparatus 1 recognizes that the unlocking operation is successful. On the other hand, when the state information indicates that the memory card 2 is in the locked state (the step S138, Locked), the host apparatus 1 recognizes that the unlocking operation has failed.

2.5.3 Operation of Memory Card 2

Next, the operation of the memory card 2 in the above step S136 will be described with reference to FIG. 20. FIG. 20 is a flowchart showing the processing in the memory card 2.

As shown in the drawing, when the execution command of the unlocking operation (UNLOCK(U), UNLOCK(M)) is received from the host apparatus 1, for example, the CPU 70 of the memory card 2 judges whether the unlocking operation is the unlocking operation using the user key, or the unlocking operation using the master key (step S141).

In the case of the unlocking operation using the user key (the step S141, No: Ku or Nt), the CPU 70 judges whether or not the key ciphering is enabled (step S142). When the key ciphering is enabled (the step S142, Enabled: Nt), the CPU 70 determines the conversion function H( ) corresponding to the code Cch received from the host apparatus 1, and further calculates the expected value Ne by use of the conversion function F( ), the ciphered user key Kuf held in the nonvolatile memory 75, and the random number Nr held as the status information in the register 72 (step S143). More specifically, the expected value Ne is calculated in accordance with Ne=H(Nr, F(Kuf, “Dec”)). Then, the CPU 70 compares the challenge number Nt received from the host apparatus 1 with the calculated expected value Ne (step S144).

As a result of the comparison, when both the values are matched (step S147, YES), the CPU 70 releases the locked state of the memory card 2 to change the card to the unlocked state (step S148). Then, the CPU 70 stores the information indicating the state as the status information in the register 72, and clears the busy state to end the unlocking operation. When a plurality of the user keys is registered, a plurality of the keys Kuf is present, and hence a plurality of the values Ne is need to be calculated. In this case, Ne matching Nt is the target user key. When one of Ne matches with the Nt, the calculation/comparison of the remaining keys Ne may be omitted.

As a result of the comparison of the step S144, when both the values are not matched (concerning all the values Ne) (the step S147, NO), the CPU 70 maintains the memory card 2 in the locked state as it is (step S149). Then, the CPU 70 clears the busy state to end the unlocking operation.

When the key ciphering is disabled in the step S142 (the step S142, Disabled: Ku), the CPU 70 ciphers the received plaintext user key Ku to calculate the expected value Kuv by use of the conversion function F( ) (step S145). More specifically, the expected value Kuv is calculated in accordance with Kuv=F(Ku, “Enc”). Then, the CPU 70 compares the ciphered user key Kuf read from the nonvolatile memory 75 with the calculated expected value Kuv (step S146). When both the values are matched (the step S147, YES), the processing proceeds to the step S148, and when the values are not matched (the step S147, NO), the processing proceeds to the step S149. When the user keys are registered, a plurality of keys Kuf is present, and hence these keys Kuf are compared with the calculated value Kuv. When one of the keys Kuf matches Kuv, the calculation/comparison of the remaining keys (Kuf) may be omitted.

In the step S141, when the received key is the master key (the step S141, YES: Km), the CPU 70 converts the received plaintext master key Km to calculate the comparison value Kmv by use of the conversion function F( ) (step S150). More specifically, the comparison value Kmv is calculated in accordance with Kmv=F(Km, “Enc”). Then, the CPU 70 compares the expected value Kmf of the master key read from the nonvolatile memory 75 with the calculated comparison value Kmv (step S151). When both the values are matched (step S152, YES), the CPU 70 erases all the user keys Kuf recorded in the nonvolatile memory 75 (step S153), to proceed to the step S148. When the values are not matched (the step S152, NO), the processing proceed to the step S149.

2.5.4 “UNLOCK(U)” and “UNLOCK(M)” Sequence

Next, a sequence in the execution of the above “UNLOCK(U)” and “UNLOCK(M)” operations will be described.

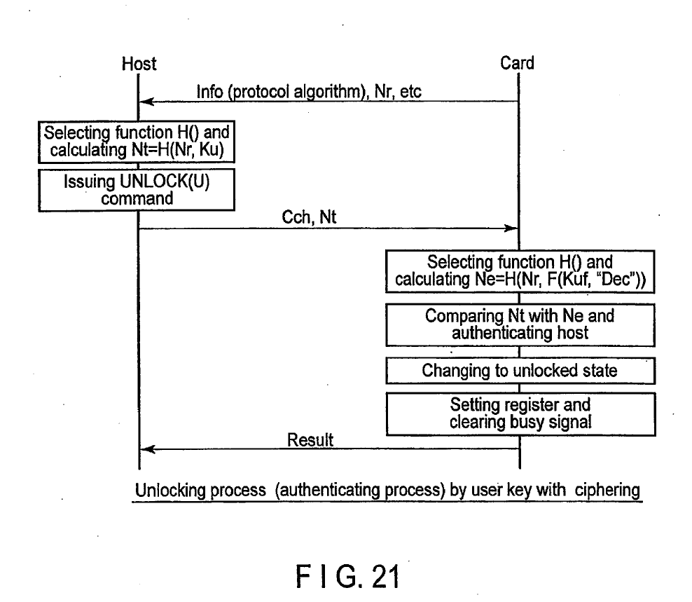

FIG. 21 shows the “UNLOCK(U)” sequence of the case where the key ciphering is enabled.

As shown in the drawing, the host apparatus 1 first reads the card information (the protocol/algorithm of the ciphering (the H( ) list) or the random number Nr), for example, from the register 72 of the memory card 2. Then, the host apparatus 1 selects the usable conversion function H( ) from the H( ) list, and ciphers the user key Ku by using the random number Nr, to calculate the challenge number Nt (=H(Nr, Ku)). Furthermore, the host apparatus 1 issues an “UNLOCK(U)” command. Then, the host apparatus 1 transmits the code Ccg indicating the selected H( ) and the challenge number Nt to the memory card 2, and transmits the UNLOCK(U) command to the memory card 2.

The memory card 2 reads the ciphered user key Kuf stored in the nonvolatile memory 75, and deciphers (decodes) the key by the conversion function F( ), to obtain the plaintext user key Ku. Then, the memory card 2 selects the conversion function H( ) on the basis of the received code Cch, and calculates the expected value Ne (=H(Nr, F(Kuf, “Dec”))).

Then, the memory card 2 compares the challenge number Nt with the expected value Ne. As described in the “Clear User Key” sequence, when a plurality of the ciphered user keys Kuf is stored in the nonvolatile memory 75, the expected value Ne is calculated for each key, and each expected value Ne is compared with the challenge number Nt.

Then, when one of the expected values Ne matches the challenge number Nt, the memory card 2 authenticates the host apparatus 1. Then, the memory card 2 changes from the locked state to the unlocked state. Then, the memory card 2 notifies the host apparatus 1 of the completion of the change to the unlocked state.

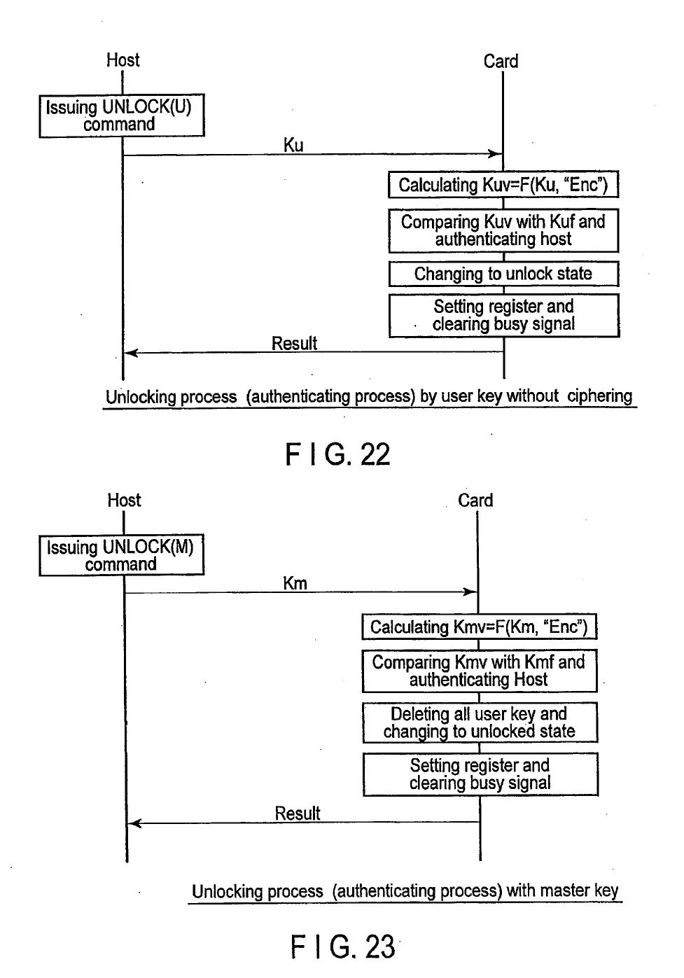

FIG. 22 shows the “UNLOCK(U)” sequence of the case where the key ciphering is disabled.

The status information indicating that the ciphering is disabled is stored in the status register 72, but it is presumed that the host apparatus 1 has already read this register, and hence the status information is omitted from FIG. 22. As shown in the drawing, the host apparatus 1 first issues the UNLOCK(U) command. Then, the host apparatus transmits, to the memory card 2, the UNLOCK(U) command together with the plaintext user key Ku.

Then, the memory card 2 ciphers the received plaintext user key Ku by using the conversion function F( ), to obtain the comparison value Kuv. Then, the memory card 2 compares the comparison value Kuv with the ciphered user key Kuf held in the nonvolatile memory 75. Then, when any Kuf matches Kuv, the memory card 2 authenticates the host apparatus 1. Then, the memory card 2 changes from the locked state to the unlocked state. Then, the memory card 2 notifies the host apparatus 1 of the completion of the change to the unlocked state.

It is to be noted that although not shown in the drawing, there is also a method in which Kuv is calculated in accordance with Kuv=F(Kuf, “Dec”), and compared with Ku.

FIG. 23 shows the “UNLOCK(M)” sequence especially in a case where the master key Km is not ciphered.

As shown in the drawing, the host apparatus 1 first issues an UNLOCK(M) command. Then, the host apparatus transmits, to the memory card 2, the UNLOCK(M) command together with the plaintext master key Km.

Then, the memory card 2 converts the received master key Km by using the conversion function F( ), to obtain the comparison value Kmv. Then, the memory card 2 compares the expected value Kmf stored in the nonvolatile memory 75 with the calculated comparison value Kmv. Then, when the expected value Kmf matches Kmv, the memory card 2 authenticates the host apparatus 1. Then, the memory card 2 erases all the user keys Kuf held in the nonvolatile memory 75, and changes from the locked state to the unlocked state. Then, the memory card 2 notifies the host apparatus 1 of the completion of the change to the unlocked state.

It is to be noted that although not shown in the drawing, there is also a method in which Kmv is calculated in accordance with Kmv=F(Kmf, “Dec”), and compared with Km.

2.5.5 Unlocking Operation when Master Key is Lost

Next, the step S125 of FIG. 18, i.e., the unlocking operation of a case where the master key Km is lost will be described.

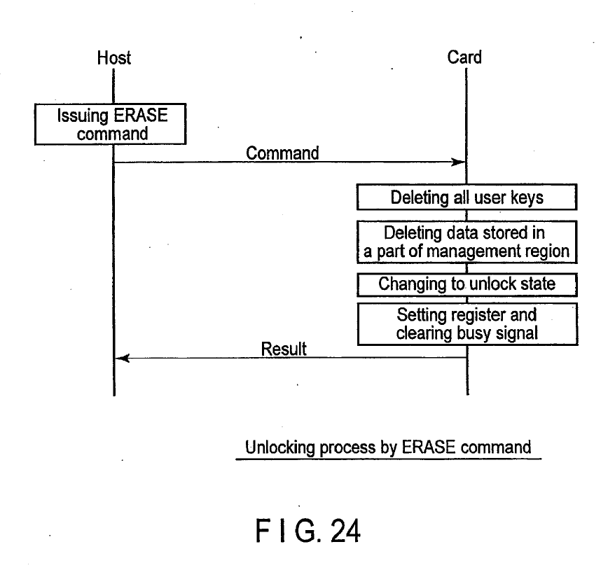

As described above, when both the user key Ku and the master key Km are lost, the memory card 2 can be changed to the unlocked state by initializing the data in the memory card 2. FIG. 24 shows a sequence of the processing in the host apparatus 1 and the memory card 2.

The host apparatus 1 which has accepted, from the user, a command to initialize of the data and to unlock the memory card 2 issues an erase command to the memory card 2. This erase command is one type of unlocking command which is prepared separately from a usual memory data erase command.

Then, the memory card 2 erases all the user keys Kuf stored in the nonvolatile memory 75. Furthermore, the memory card 2 erases a part of the file system information in the management area 50. In the user data area, a part of the information stored in the user data area is erased or the information is shuffled to shorten the time for disabling the data. As to important data, the host apparatus individually ciphers the file, whereby the leakage of the data can be avoided. Then, the memory card 2 changes from the locked state to the unlocked state. Afterward, the memory card 2 notifies the host apparatus 1 of the completion of the change to the unlocked state.

The memory card which has received the erase command erased the data in the vicinity of the FAT1 or FAT2 of FIG. 2, so that the data of the memory card 2 cannot be read from the host apparatus 1. The host apparatus 1 usually identifies this card as “an unformatted card”. When the card is formatted again, the card is usable again. In the memory card 2, the file system management area 50 does not strictly have to be erased, and the required size of the management area 50 can roughly be predicted from the memory capacity. Therefore, the data of the area including at least the FAT1 and FAT2 may be erased, or a FAT code indicating non-use may be overwritten. Therefore, the memory card 2 does not have to recognize the format of the file system. The file system is constituted by not only the FAT but also a bit map sometimes.

2.6 Locking Operation

Next, there will be described the locking operation for changing the memory card 2 in the unlocked state to the locked state in the memory system according to the present embodiment.

2.6.1 Operation of Host Apparatus 1

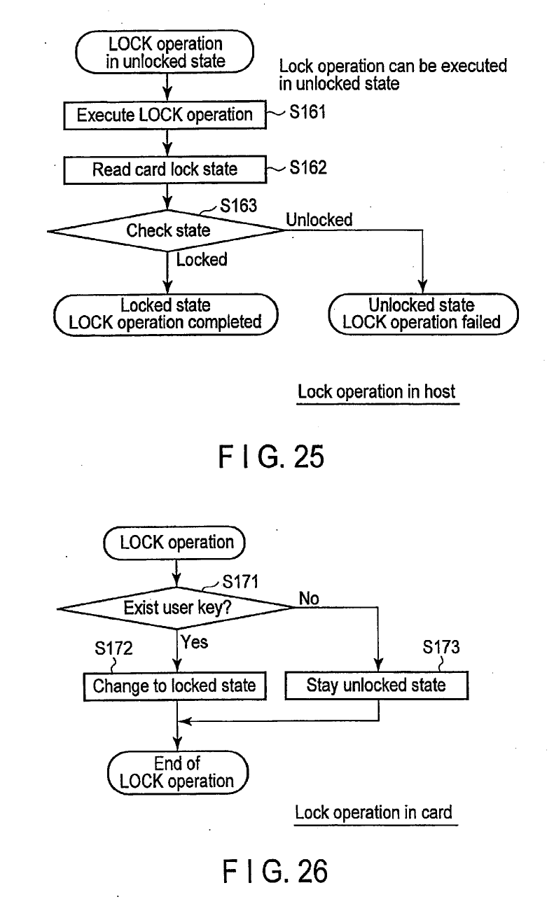

As to the locking operation according to the present embodiment, the processing in the host apparatus 1 will first be described with reference to FIG. 25. FIG. 25 is a flowchart showing the processing of the host apparatus 1 in the locking operation. It is to be noted that the locking operation is executable when the memory card 2 is in the unlocked state.

First, the CPU 60 of the host apparatus 1 reads the status information of the register 72 of the memory card 2, and confirms that the memory card 2 is in the unlocked state. Afterward, the CPU 60 issues a locking command, and transmits the locking command from the host controller 65 to the memory card 2.

Then, the locking operation is executed in the memory card 2 (step S161). Then, when the busy signal is cleared and the end of the locking operation in the memory card 2 is notified, the CPU 60 of the host apparatus 1 reads the status information from the memory card 2 again (step S162), and checks whether or not the locking operation is successful (step S163).

When the state information included in the status information indicates that the memory card 2 is in the locked state, the locking operation is successful, and if not so, the locking operation fails.

2.6.2 Operation of Memory Card 2

Next, the operation of the memory card 2 will be described. FIG. 26 is a flowchart showing the processing in the memory card 2, and corresponds to the contents of the processing executed in the step S161 in FIG. 25.

As shown in the drawing, the CPU 70 of the memory card 2 first judges whether or not the user key is registered (step S171). This judgment may be executed by checking whether or not the user key Kuf is held in the nonvolatile memory 75, or may be executed by checking the status information of the register 72.

When the user key is registered (the step S171, YES), the CPU 70 changes the memory card 2 to the locked state (step S172). When the user key is not registered (the step S171, NO), the CPU 70 maintains the memory card 2 in the unlocked state (step S173).

Afterward, the CPU 70 updates the status information of the register 72, clear the busy state, and notify the host apparatus 1 of the end of the locking operation.

3. Specific Examples of Operation

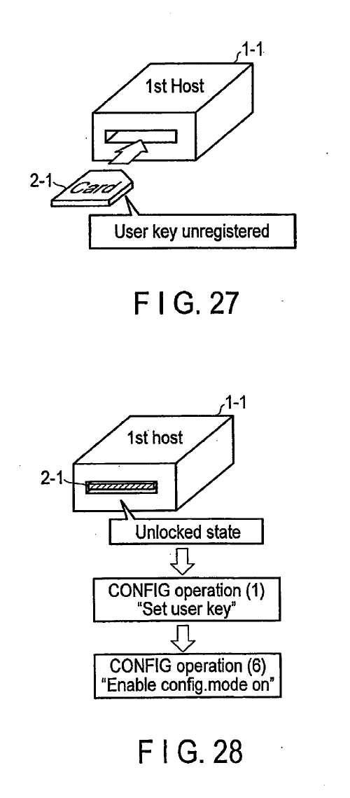

Specific examples of a user key registering operation of the above memory system will be described with reference to FIG. 27 to FIG. 32. FIG. 27 to FIG. 32 are schematic views of the memory system, and successively show the behavior that the user key is registered in two host apparatuses 1-1 and 1-2 and then the host apparatus 1-1 performs the unlocking operation.

As shown in FIG. 27, a first memory card 2-1 in which the user key is not registered is connected to the first host apparatus 1-1. As shown in FIG. 28, the memory card 2-1 is in the unlocked state. Therefore, the memory card 2-1 executes initialization in the unlocked state, and changes to the transfer state. Next, the first host apparatus 1-1 executes the “Set User Key” function of the configuration operation, to register a first user key Ku1. The first host apparatus 1-1 ciphers the registered first user key Ku1, and stores a ciphered first user key Kuf1 (=F(Ku1, “Enc”)) in the register 63 of the first host apparatus 1-1. Furthermore, the ciphered first user key Kuf1 ciphered by the memory card 2-1 is stored in the nonvolatile memory 75 of the memory card 2-1. Then, the first host apparatus 1-1 executes the “Enable Config. Mode” function of the configuration operation, to turn on the configuration mode, in order to register the user key by the second host apparatus 1-2.

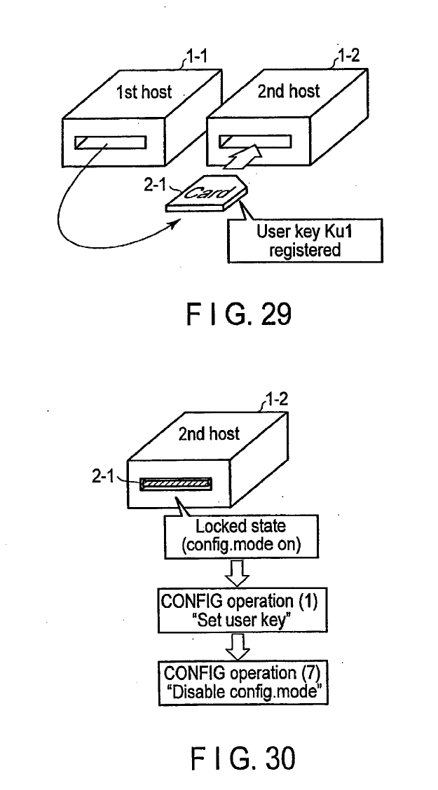

Next, as shown in FIG. 29, the memory card 2-1 is connected to the second host apparatus 1-2. As shown in FIG. 30, the user key Ku1 is already registered in the memory card 2-1, and hence the memory card 2-1 is in the locked state. Therefore, the memory card 2-1 executes the initialization in the locked state, and changes to the transfer state. When the memory card 2-1 changes to the transfer state, the second host apparatus 1-2 can read at least a part of the file system information, though the memory card 2-1 is in the locked state. Therefore, the second host apparatus 1-2 can recognize the memory card 2-1, and can allot a drive letter to the memory card 2-1 as a drive. Moreover, in the memory card 2-1, the configuration mode is turned on, and hence the second host apparatus 1-2 can execute the configuration operation. Therefore, the second host apparatus 1-2 executes the “Set User Key” function of the configuration operation, to register a second user key Ku2. The second host apparatus 1-2 ciphers the registered second user key Ku2, and stores a ciphered second user key Kuf2 (=F(Ku2, “Enc”)) in the register 63 of the second host apparatus 1-2. Furthermore, the ciphered second user key Kuf2 ciphered by the memory card 2-1 is stored in the nonvolatile memory 75 of the memory card 2-1. The second user key Ku2 may be the same as or different from the first user key Ku1. Usually, when information exchange cannot be performed between the first host apparatus 1-1 and the second host apparatus 1-2, the different keys are used (it is difficult to use the same key). Then, the second host apparatus 1-2 executes the “Disable Config. Mode” function of the configuration operation, to turn off the configuration mode.

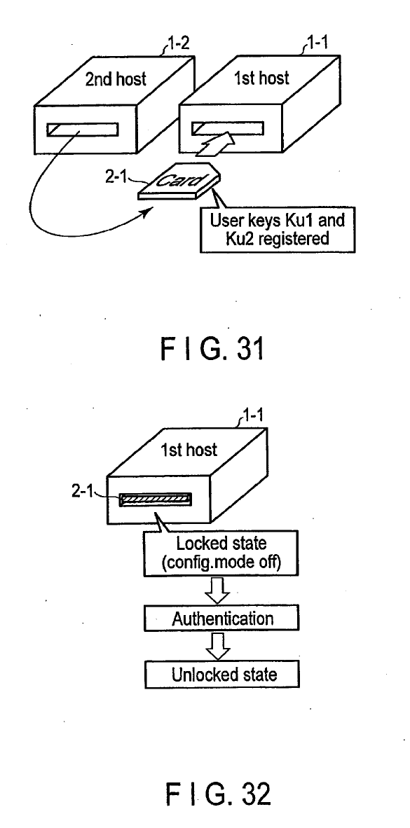

Next, as shown in FIG. 31, the memory card 2-1 is connected to the first host apparatus 1-1. Then, as shown in FIG. 32, the user keys Ku1 and Ku2 are already registered, and hence the memory card 2-1 is in the locked state. However, similarly to the second host apparatus 1-2, the first host apparatus 1-1 can recognize the memory card 2-1 in the locked state as the drive. Then, the first host apparatus 1-1 performs the unlocking operation by using the user key Ku1 stored in the register 63, and changes the memory card 2-1 from the locked state to the unlocked state. The memory card 2-1 compares two registered user keys with Kuf1, and when one of the keys is matched (Ku1 in this case), the card changes to the unlocked state. In consequence, the user can freely access the memory card 2-1.

In FIG. 32, if the user key Ku1 is lost from the register 63 and the unlocking operation using the user key Ku1 cannot be executed, the unlocking operation using the master key Km is executable. In this case, the two user keys Kuf1 and Kuf2 stored in the memory card 2-1 are both erased.

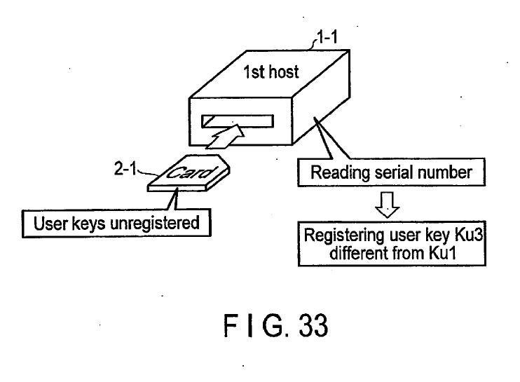

FIG. 33 shows a case where a second memory card 2-2 is registered in the first host apparatus 1-1. The first host apparatus 1-1 can identify the card by use of the unique information of the memory card 2-2 (e.g., a serial number or the like is used, and a command to read the serial number is prepared in the memory card). Therefore, the first host apparatus 1-1 can identify the first memory card 2-1 and the second memory card 2-2, and can allocate different user keys Ku to the respective cards.

Furthermore, when the host apparatus identifies the memory card by the unique information of the card, the host apparatus can identify a specific key for setting the memory card to the unlocked state.

4 Effect According to the Present Embodiment

In the memory system according to the present embodiment, a convenience of the memory card can be enhanced, and a security level can be enhanced. Hereinafter, the present effect will be described in detail.

4.1 the Memory Card Even in the Locked State can be Mounted as the Drive.

In the memory card according to the present embodiment, as described in the paragraphs of the above 1.4, the file system information can be read though the memory card is in the locked state. Therefore, the host apparatus 1 can recognize the memory card 2 in the locked state, and can allocate the drive letter to the memory card as the drive. That is, for the purpose of recognizing the card as the drive, it is not necessary to execute the unlocking operation. Therefore, a procedure of mounting the memory card 2 as the drive can be simplified, and user's convenience can be enhanced.

4.2 Common Initialization Sequence

Furthermore, in the memory system according to the present embodiment, as described in the paragraphs of the above 2.1, after an initialization sequence of the memory card 2 is completed and the memory card 2 changes to the transfer state, the locking operation or the unlocking operation is executed. That is, the initialization sequence is completely separated from the locking/unlocking operation, and the initialization sequence is first executed. For example, heretofore, there has been the problem that a bus width cannot be switched from 1-bit to 4-bit in the locked state, and hence the transfer mode cannot be set until the memory card is set to the unlocked state. However, such a problem is solved. Further, in the present embodiment, the control command is executable irrespective of the locked state or the unlocked state.

Therefore, in the memory system with the lock/unlock function and the memory system without the function, the initialization sequence can be used in common. In consequence, the designing of the memory system is facilitated. Furthermore, without considering whether or not the memory card 2 uses the lock/unlock function, any type of host apparatus 1 can use the memory card 2, which can enhance the user's convenience.

Moreover, as described with reference to FIG. 10, the registration processing of the user key is completed roughly in three steps. That is, there are the three steps of reading various pieces of information from the memory card 2, transmitting the user key to the memory card 2, and notifying the host apparatus 1 of the registration completion. Therefore, the processing can considerably be simplified.

4.3 Advancement of Security Level

Furthermore, in the memory system according to the present embodiment, the user key can be transmitted/received between the host apparatus 1 and the memory card 2 in a ciphered state. Additionally, the information on the used function does not indicate the function itself, but is the code Cch or Ccg indicating selection information of the function. Therefore, even when these pieces of information are leaked, a disguising by an illegal host apparatus can be prevented and the tamper-resistance can be enhanced, thereby the security level is enhanced.

Moreover, the user key Ku can be prepared by the management utility as described in the paragraphs of the above 1.5.2. The management utility is executed by the CPU 60, to function as user key preparing means. Then, the management utility can prepare the user key unique to the host apparatus and having a password length of a level which cannot be input by a manual input of a person. Basically, the security level of the password noticeably depends on the password length. Therefore, as compared with a conventional technology, the security level can remarkably be advanced by using the management utility.

Furthermore, the user key can individually be set for each host apparatus and each memory card. This aspect also contributes to the advancement of the security level.

Additionally, by using the management utility, the user does not have to be requested to input the password every time the memory card 2 is connected to the host apparatus 1. That is, automatic authentication is performed between the host apparatus 1 and the memory card 2, and the memory card 2 in the locked state automatically changes to the unlocked state, when the memory card is authenticated. Therefore, the user does not have to recognize that the memory card 2 is in the locked state, and can freely access the memory card 2 immediately after the memory card 2 is connected to the host apparatus 1. Also in this respect, the user's convenience can be enhanced. Moreover, one host apparatus can manage the user keys of a plurality of the cards. In this case, the host apparatus 1 identifies the cards by reading the unique information of the each card (for example, the serial number), and manages the cards by correlating the serial number with the user key.

4.4 Password Loss Countermeasure

In the memory system according to the present embodiment, the user key Ku is prepared. Then, the registration of the user key enables the locking operation of the memory card 2. Furthermore, when the user keys can be registered, rights of use can be set to the host apparatuses 1. Then, the user key is also used to change the memory card 2 in the locked state to the unlocked state.

Furthermore, in preparation for a case where the user key is lost, the master key Km is prepared in the present embodiment. The master key Km is set, for example, at the shipping of the memory card 2, and is prohibited from being changed by the user. Additionally, by use of the master key, it is possible to change the memory card 2 to the unlocked state while erasing all the registered user keys. For example, at the shipping of the memory, the master key is programmed, and sold in a printed state. When the user stores the master key at home without carrying the key, there are not any security problems in a usual use environment.

4.5 Shortening Time of “Force Erasing” Period

Furthermore, when both the user key and the master key are lost as described in the paragraphs of the above 2.5.5, the memory card 2 can be changed to the unlocked state by executing the erasing operation.

In this case, in the memory card 2, all the user keys and a part of the file system information are erased from the nonvolatile memory 75. A part of the user data area is erased, or the data is shuffled, whereby a disabling time of the user data area can be shortened, and the host apparatus 1 can be prevented from being in a frozen state over a long period of time. It is to be noted that in this case; the formatting is required to set the memory card 2 to the usable state. The data in the user data area is not completely erased and a piece of data is left, but the individual piece of data can be protected, for example, by individual ciphering by the user.

4.6 Expansion of Configuration Operation

When a configuration operation command is expanded to set the memory card to the unlocked state, for example, by a specific user key, it is possible to add such setting that the reading is only allowed and the writing is impossible.

5. Modifications

As described above, in the device, the host apparatus, the host system, and the memory system according to the above embodiment, the user's convenience can be enhanced.

It is to be noted that the above embodiment is not the only one embodiment, but can variously be modified. That is, the above one embodiment includes a plurality of aspects, and only a part of the aspects may be carried out.

5.1 First Modification

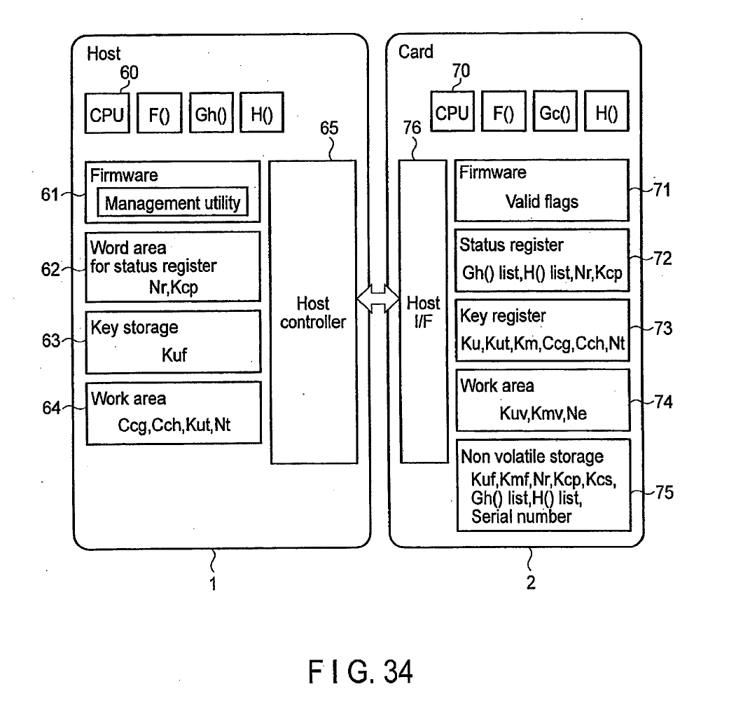

A first modification will be described. FIG. 34 is a block diagram of a memory system according to the present modification. As shown in the drawing, the present modification corresponds to the structure in which a firmware further includes a valid flag in FIG. 5. The valid flag is information indicating whether data of a user data area (an area accessible from the outside) in a nonvolatile memory 75 is valid or invalid.

The valid flag will be described with reference to FIG. 35. FIG. 35 is a schematic view of a firmware 71 in a memory card 2 and the user data area in the nonvolatile memory 75. FIG. 35 shows the above-mentioned MBR and BPB as boot sectors.

As shown in the drawing, in the nonvolatile memory 75, the user data area accessible from the outside (a file system management area 50 and a file system data area 51) is divided into management units MUs (MU1 to MUn) and managed. n is a natural number of 2 or more. The reading and writing of the data are performed in units of the management units. One management unit corresponds to one or more physical units.

Furthermore, the memory card 2 includes a valid flag VF (VF1 to VFn) for each management unit MU. The valid flag VF is stored in an area where the data is held even when power is shut down, for example, in a nonvolatile memory. Then, the valid flag VF indicates whether or not the corresponding management unit MU holds a valid value, i.e., whether or not the area corresponding management unit MU is recognized, by a host apparatus 1, as a data-erased area.

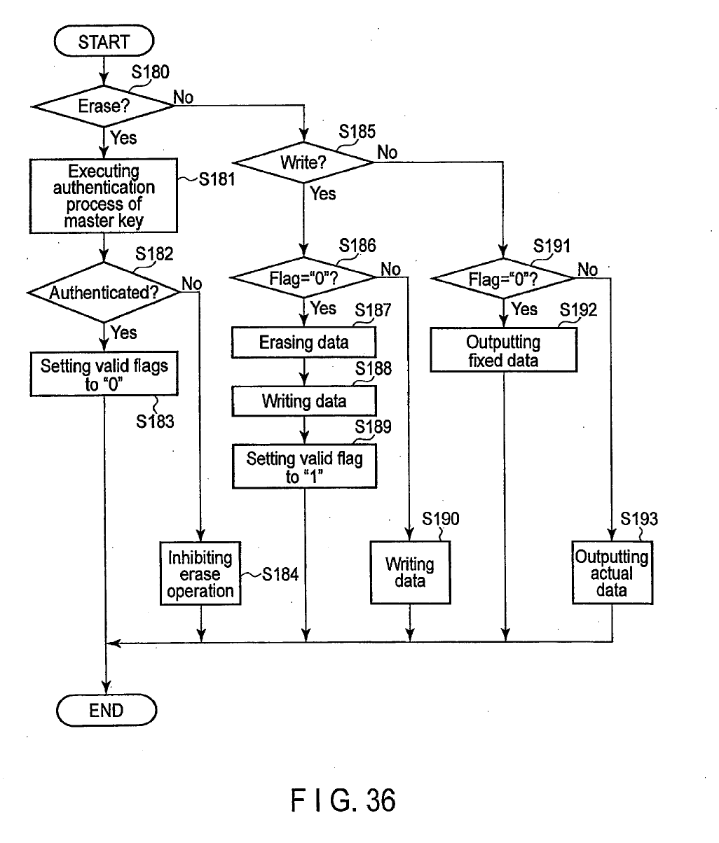

FIG. 36 is a flowchart showing an operation of the memory card 2 when the memory card receives an erasing, writing or reading access from the host apparatus 1. These operations are executed mainly by the control of a CPU 70.

As shown in the drawing, when the access from the host apparatus 1 is a data erasing instruction (step S180, YES), the CPU 70 executes an authenticating operation of a master key (step S181). This authentication processing is similar to, for example, the processing described with reference to FIG. 23. That is, for example, the memory card 2 requests the host apparatus 1 to input the master key. In response to this request, the host apparatus 1 transmits a plaintext master key Km to the memory card 2. Then, the memory card 2 converts the received master key Km by a conversion function F( ), to obtain a comparison value Kmv. Then, the memory card 2 compares an expected value Kmf stored in the nonvolatile memory 75 with the calculated comparison value Kmv. Then, when the expected value Kmf matches Kmv, the memory card 2 authenticates the master key Km.

When the master key is authenticated (the step S182, YES), the CPU 70 sets all the valid flags VFs to “0” (step S183). However, the actual data itself stored in the management unit MU of the nonvolatile memory 75 is not erased. It is note that the term of “erase” described herein relates to the erasing of previously stored user data and does not mean whether an erase command of the nonvolatile memory is executed or not.

When the authentication of the master key fails (the step S182, NO), the erasing is not performed (step S184), and, for example, a status error is transmitted to the host apparatus 1.

Next, there will be described a case where the access from the host apparatus 1 is the writing instruction (the step S180, NO, and step S185, YES). In this case, the CPU 70 checks the valid flag VF corresponding to the management unit MU for an accessed area (step S186). When the valid flag VF is “0”, it is meant that in the management unit MU seen from the host apparatus 1, the data is erased (actually, the data is left in the management unit MU). Therefore, the CPU 70 actually erases the data in the management unit MU (step S187). Then, the CPU 70 writes, in the management unit MU, the write data received from the host apparatus 1 (step S188), and the CPU sets the corresponding valid flag VF to “1” (step S189).

When the valid flag VF is “1” in the step S186, the erasing is not required, and the write data is written in the corresponding management unit MU (step S190). The valid flag VF remains at “1”.

Next, there will be described a case where the access from the host apparatus 1 is the reading instruction (the step S180, NO, and the step S185, NO). In this case, the CPU 70 checks the valid flag VF corresponding to the management unit MU for the accessed area (step S191). When the valid flag VF is “0” (the step S191, YES), the CPU 70 does not read the data from the nonvolatile memory 75, but outputs predetermined fixed data (data in which all bits are “1”, or data in which all bits are “0”) to the host apparatus 1 (step S192).

On the other hand, when the valid flag VF is “1” (the step S191, NO), the CPU 70 reads the data from the corresponding management unit MU of the nonvolatile memory 75, and outputs this data to the host apparatus 1 (step S193).

According to the above structure, to perform the erasing operation, the authentication of the master key has to be passed. This can prevent the memory card 2 from being initialized by a person other than an owner of the memory card 2 (the flowchart of FIG. 18 shows the embodiment where the data can be erased by the erasing operation when the master key is forgotten, but the present modification is different in that the master key is used to allow the erasing).

Moreover, according to the present modification, when the erasing command of the data is received, the actual data stored in the nonvolatile memory 75 is not erased. Instead, the CPU 70 manages the erase-target data by using the valid flag VF. In this way, the actual data erasing operation is not required, and hence an operation speed of the memory card 2 can be enhanced. Furthermore, when a data reading request is received, the CPU 70 first refers to the valid flag VF. Then, when VF=“0”, the fixed data is output without reading the data from the nonvolatile memory 75. Therefore, even when the actual data is left in the nonvolatile memory 75, this data can be prevented from being wrongly read.

It is desirable that the MBR and BPB exceptionally are readable regardless of the valid flag. In this case, the valid flags associated with a region of a leading address of the management region 50 or a part of the management region 50 is fixed to “1” or is excluded from the “valid flag management”.

5.2 Other Modifications

The modification is not limited to the above modification. For example, an aspect in which a part of file system information is readable in the locked state may be alone carried out. Moreover, the case where seven functions are included in the configuration operation has been described as an example, but only a part of these functions may be carried out.

Moreover, when one type of ciphering system for use between the host apparatus 1 and the memory card 2 is determined in advance, it is not necessary to transmit the code Cch or Ccg, and the memory card does not have to hold the Gh( ) list and the H( ) list. Additionally, the ciphering system is not limited to the system described in the above embodiment, and the other various systems can be applied.

Furthermore, means for notifying the host apparatus 1 of the end of various operations by the memory card 2 is not limited to the busy signal, and another signal may be used. When the busy state is completed, the card may send a packet to the host apparatus to notify the host apparatus.

Additionally, concerning the handling of the user key in the configuration operation, three types, i.e., the registration, the deletion and the checking have been exemplified, but a user key change function may be included. In this case, the host apparatus 1 performs an authenticating operation by using the change-target user key, and then the host apparatus 1 may issue a change command together with a new user key. The new user key may be prepared by the management utility, or input by the user. Furthermore, the user key may be ciphered, or may not be ciphered.

Moreover, in the above embodiment, as an example of the memory device, the SD memory card has been described. However, the memory device is not limited to the SD memory card, and may be any storage medium. Furthermore, the number of devices to be connected to the host apparatus 1 is not limited to one, and two or more devices may simultaneously be connected. In this case, the host apparatus 1 individually performs a user key registering operation for each device. Furthermore, the file system is not limited to a FAT file system. The memory card 2 does not have to identify the file system, and as an area which is restrictedly readable in a locked state or an area to be erased by an erasing command, an area predicted from a memory capacity can be used. These areas do not need to be strictly determined.

Furthermore, the order of the flowcharts and sequence diagrams described in the above embodiment may be changed as necessary, and a plurality of processing steps may be simultaneously be executed. Additionally, a structure of the host apparatus 1 and the memory card 2 are not limited to FIG. 1 and FIG. 5. As long as the functions described in the above embodiment can be realized, each of the structure is not limited to hardware or software, and there is no special restriction on the structure.

The above embodiments include the following aspects.

[1] A device comprising:

a semiconductor memory (31 in FIG. 1) including first and second areas which are accessible from the outside; and

a controller (32 in FIG. 1) which controls the semiconductor memory,

wherein the device includes an unlocked state where reading from the first area and the second area is allowed, and a locked state where the reading from the first area is allowed, and the reading from the second area is prohibited,

the first area stores at least part of file system information (FAT and DIR entry in FIG. 2), and

in the locked state, the at least part of the file system information is readable from the outside (FIG. 3).

[2] The device according to [1],

wherein the semiconductor memory is configured to hold at least one ciphered user key (Kuf in FIGS. 5, 9) prepared by ciphering a user key registered in the device by a first cipher function (F( ) in FIG. 9),

when the user key is registered, the controller performs initialization in the locked state immediately after power is turned on (FIG. 30),

when the user key is not registered, the controller performs the initialization in the unlocked state immediately after the power is turned on (FIG. 28),

the initialization is executed by the same sequence, when the user key is registered and when the user key is not registered (FIG. 6),

in the initialization, any one of bus transfer modes is selected, the bus connecting between a host and a card, and

in the locked state, the at least part of the file system information is accessible from the outside, after the initialization of the device (FIG. 3).

[3] The device according to [1] or [2],

wherein in the unlocked state, a configuration operation enables registration, change and deletion of the user key, and allows the reading from both the first and second areas (FIG. 3),

the locked state includes a first mode (Config. Mode On) and a second mode (Config. Mode Off), and in the first mode, the configuration operation allows the registration, the change and the deletion of the user key, and prohibits change to the unlocked state, and in the second mode, the configuration operation prohibits the registration, the change and the deletion of the user key, and enables the change to the unlocked state (FIG. 4).

[4] The device according to [1] to [3],

wherein the controller compares a key received from the outside with the user key registered in the device (S144, S146 in FIG. 20),

when the comparison result is matched, the device changes from the locked state to the unlocked state (S148 in FIG. 20).

[5] The device according to [4],

wherein the semiconductor memory stores a master key (Kmf in FIG. 5) which is registered in advance and is not changed by the configuration operation,

the controller compares the key received from the outside with the master key (S151 in FIG. 20),

when the comparison result is matched, the controller deletes the registered user without erasing the user data area (S153 in FIG. 20), and the device changes from the locked state to the unlocked state (S148 in FIG. 20).

[6] The device according to [1] or [2],

wherein the user key for changing the device between the locked state and the unlocked state is registerable in the device,

when the user key is not registered, the controller includes a function of setting enabling/disabling of key ciphering, and when the user key is registered, the setting is fixed (FIG. 16),

the controller includes a second cipher function (Gc( ) in FIG. 8) and a third cipher function (H( ) in FIG. 20) which are usable in the key ciphering,

the second cipher function (Gc( ) in FIG. 8) is used in the registration of the user key, and the third cipher function (H( ) in FIG. 20) is used in authentication of the user key, and

the user key is ciphered by the second or third cipher function, and transmitted from the outside to the device (FIGS. 10, 14).

[7] The device according to [6],

wherein a master key for authentication to delete the user key is registerable in the device, and

even when the key ciphering is set to be enabled, the master key is not ciphered, and is transmitted to the device (FIG. 23).

[8] A host apparatus which is accessible to a device including a locked state and an unlocked state, comprising:

a host memory (63 in FIG. 5) which is configured to store a user key; and

a host controller (60, 65 in FIG. 5) which controls the device,

wherein, the controller initializes the device, and then reads at least part of file system information from the device irrespective of whether the device is in the locked state or the unlocked state, to recognize that the device is a formatted memory device,

the host controller initializes the device, and then checks whether the device is in the locked state or the unlocked state, and

when the device is in the locked state, the controller transmits the user key to change the device to the unlocked state.

[9] The host apparatus according to [8],

wherein when the at least part of the file system information is read and the device is recognized as the formatted memory device,

a drive number is allocated to the device as a drive to enable an access from an application to the device as the drive.

[10] The host apparatus according to [8] or [9],

wherein when the host controller transmits the user key to the device,

the host controller selects one of third cipher functions supported by the device,

ciphers the user key by using the selected cipher function (H( ) in FIG. 19), and

transmit the ciphered user key (S134-135 in FIG. 19).

[11] The host apparatus according to [10],

wherein the host controller prepares the user key, and stores a ciphered user key (Kuf in FIG. 5) obtained by ciphering the prepared user key by using a conversion function (F( ) in FIG. 10), in the host memory (63 in FIG. 5) in a nonvolatile manner, and

the host controller stores the ciphered user key in the host memory, and then transmits the user key to the device.

[12] The device of [1],

wherein the controller manages the first and second areas as a set of unit areas, and manages the first area except for a leading address region and the second area by using a flag for each of the unit areas, and

when the controller receives a data erasing command from the outside, the controller sets the flag to a value indicating that the data has been erased without erasing the data in the second area.

[13] The device of [12],

wherein when the controller receives the erasing command, the controller requests the outside to authenticate a master key, and

when the master key is authenticated, the controller sets the flag.

[14] The device of [12],

wherein when the controller receives a data writing command from the outside, the controller checks the flag, and

when the flag is set, the controller erases the data in a corresponding area of the second area, and then writes the data into the area.

[15] The device of [12],

wherein when the controller receives a data reading command from the outside, the controller checks the flag, and

when the flag is set, the controller outputs fixed data to the outside.

[16] A host system comprising:

a first host apparatus (1-1 in FIG. 27) including the host apparatus recited in [8]; and

a second host apparatus (1-2 in FIG. 27) including the host apparatus recited in [8],

wherein the first host apparatus sets a first user key to the device, and enables a mode (Config. Mode in FIG. 27) for registering the user key for the device in the locked state (FIG. 28),

the second host apparatus initializes the device in which the mode is enabled by the first host apparatus, sets a second user key, and disables the mode (FIG. 30), and

when the mode is disabled, the device is set to be capable of changing from the locked state to the unlocked state (FIG. 32).

[17] The host system according to [16],

wherein the device in which the first and second user keys are set is usable by the first and second host apparatuses by authenticating operations using the first and second user keys, respectively.

[18] A memory system comprising:

the device (2 in FIG. 5) recited in [1]; and

the host apparatus (1 in FIG. 5) recited in [8],

wherein when the user key is registered,

the host apparatus generates the user key, ciphers the user key by using a first cipher function of the host apparatus, stores the ciphered user key in the host memory of the host apparatus, and ciphers the user key by using a second cipher function (Gh( ) in FIG. 10) and a public key (Kcp in FIG. 10), and

the device decodes the ciphered user key, ciphered by the second cipher function and the public key, by using a decode function (Gc in FIG. 10) and a secret key (Kcs in FIG. 10), ciphers the decoded user key by using a first cipher function (F( ) in FIG. 10) of the device, and stores the user key in the semiconductor memory.

[19] The memory system according to [18],

wherein the host apparatus decodes the ciphered user key (Kuf in FIG. 5) stored in the host memory of the host apparatus by using a conversion function (F( ) in FIG. 5) to obtain the user key, and

the device decodes the ciphered user key (Kuf in FIG. 5) stored in the semiconductor memory of the device by using the first cipher function of the device to obtain the user key (Ku=F(Kuf, “Dec”) in FIG. 21).

[20] A memory system comprising:

the device (2 in FIG. 5) recited in [1]; and

the host apparatus (1 in FIG. 5) recited in [8],

wherein when the user key is authenticated,

the host apparatus ciphers the user key by using a third cipher function (H( ) in FIG. 21) and a random number (Nr in FIG. 21) supplied by the device,

the device authenticates, the user key (Nt in FIG. 21) ciphered by the host apparatus, by using the third cipher function (H( ) in FIG. 21), the random number (Nr in FIG. 21), and the ciphered user key (Kuf in FIG. 21) stored in the semiconductor memory, and

when the authentication is successful, the device changes from the locked state to the unlocked state (FIG. 21).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A device comprising:
a semiconductor memory including a first area which is accessible from an outside through an interface connecting between a host and the device; and
a controller which controls the semiconductor memory,
wherein the device includes an unlocked state where accessing the first area is allowed, and a locked state where the accessing the first area is prohibited,
wherein the device is capable of holding one or more user key in the device,
wherein the device includes a function of configuration operation to register, change, and delete the user key in the semiconductor memory,
after power is turned on, the device is either in the locked state if any of user keys is registered or in the unlocked state if none of user keys is registered,
an initialization sequence is executed regardless of the device is in the locked state or the unlocked state, and
wherein in the unlocked state, the device allows for access of the first area and execution of a configuration operation,
in the locked state, the device prohibits accessing the first area and is configured either in a first mode or in a second mode, and
in the first mode of the locked state, the device allows for execution of the configuration operation, and prohibits change to the unlocked state, and in the second mode of the locked state, the device prohibits execution of the configuration operation and allows for change to the unlocked state when the comparison result is matched between a key received from the outside through the interface and one of the user keys registered in the device.

2. The device according to claim 1,
wherein the semiconductor memory stores a master key which is registered in advance and is not changed by the configuration operation, and
when the comparison result is matched between a key received from the outside through the interface and the master key registered in the device, the device deletes the registered user key, and the device changes from the locked state to the unlocked state.

3. The device according to claim 1,
wherein when any of the user keys is not registered, the device is designated whether key ciphering is enable or disabled with one of the user keys registered, and the setting of key ciphering enabled or disabled is maintained,
the device is capable of holding a ciphered user key prepared by ciphering the user key by a first cipher function.

4. The device according to claim 3, wherein the controller includes a second cipher function and a third cipher function which are usable in the key ciphering,
the second cipher function is used in the registration of the user key, and the third cipher function is used in authentication of the user key, and
the user key is ciphered by the second or third cipher function, and transmitted from the outside to the device.

5. The device according to claim 4,
wherein when the key ciphering is set to be enabled, on receiving a key from outside to be compared with a user key, the device treats the key from outside as ciphered, and on receiving a key from outside to be compared with the master key, the device treats the key from outside as un-ciphered regardless of whether the key ciphering is set to be enabled or disabled.

6. The device according to claim 1,
wherein the controller manages the first area as a set of unit areas, and manages the first area by using a flag for each of the unit areas,
when the controller receives a data erasing command from the outside, the controller sets the flag to a value indicating that the data has been erased without erasing the data in the first area, and
when the controller receives a data read command from the outside, the controller returns any data other than recorded in the first area where the flag is set.

7. The device according to claim 5,
wherein the controller accepts to receive the erasing command, when an authentication with a master key is completed successfully.

8. The device according to claim 1, wherein the semiconductor memory further includes a second area which are accessible from an outside,
in the unlocked state and the locked state, the reading from the second area is allowed, and
the second area stores at least part of file system information.

9. The device according to claim 1, wherein in the initialization sequence, any one of bus transfer modes is selected, the bus connecting between the host and the device.

10. A host apparatus which is accessible to a device including a locked state and an unlocked state, comprising:
a host memory which is configured to store a user key; and
a host controller which controls the device,
wherein the host apparatus initializes the device, and then checks whether the device is in the locked state or the unlocked state,
wherein the device is in the unlocked state, the host apparatus sets a first user key to the device and enables a first mode for registering the user key for the device in the locked state,
wherein the device is in the locked state due to a user key has been set to the device, the host apparatus which has the first user key transmits the first user key to the device to change the device to the unlocked state, and enables the first mode if the device changes to the unlocked state with the first user key, and
wherein the device is in the locked state and in the first mode, the host apparatus which has a second user key registers the second user key to the device in the first mode and then disable the first mode.

11. The apparatus according to claim 10, wherein the controller reads at least part of file system information from the device irrespective of whether the device is in the locked state or the unlocked state, to recognize that the device is a formatted memory device after initialization of the device.

12. The apparatus according to claim 11,
wherein when the at least part of the file system information is read and the device is recognized as the formatted memory device,
a drive number is allocated to the device as a drive to enable an access from an application to the device as the drive.

13. The apparatus according to claim 10,
wherein when the host controller transmits the user key to the device,
the host controller selects one of third cipher functions supported by the device,
ciphers the user key by using the selected third cipher function, and
transmit the ciphered user key.

14. The apparatus according to claim 13,
wherein the host controller prepares the user key, and stores a ciphered first user key obtained by ciphering the prepared user key by using a conversion function, in the host memory in a nonvolatile manner, and
the host controller stores the ciphered user key in the host memory, and then transmits the user key to the device.

15. A host system which is accessible to a device including a locked state and an unlocked state, the system comprising:
a first host apparatus; and
a second host apparatus,
wherein the first host apparatus sets a first user key to the device, and enables a mode for registering the user key for the device in the locked state,
the second host apparatus initializes the device in which the mode is enabled by the first host apparatus, sets a second user key, and disables the mode, and
when the mode is disabled, the device is set to be capable of changing from the locked state to the unlocked state.

16. The system according to claim 15,
wherein the device in which the first and second user keys are set is usable by the first and second host apparatuses by authenticating operations using the first and second user keys, respectively.

17. A memory system comprising:
the device recited in claim 1; and
a host apparatus accessible to the device,
wherein the host apparatus includes:
a host memory which is configured to store a user key; and
a host controller which controls the device,
wherein the host apparatus initializes the device, and then checks whether the device is in the locked state or the unlocked state,
wherein the device is in the unlocked state, the host apparatus sets a first user key to the device and enables a first mode for registering the user key for the device in the locked state,
wherein the device is in the locked state due to a user key has been set to the device, the host apparatus which has the first user key transmits the first user key to the device to change the device to the unlocked state, and enables the first mode if the device changes to the unlocked state with the first user key, and
wherein the device is in the locked state and in the first mode, the host apparatus which has a second user key registers the second user key to the device in the first mode and then disable the first mode,
wherein when the user key is registered,
the host apparatus generates the user key, ciphers the user key by using a first cipher function of the host apparatus, stores the ciphered user key in the host memory of the host apparatus, and ciphers the user key by using a second cipher function and a public key, and
the device decodes the ciphered user key, ciphered by the second cipher function and the public key, by using a decode function and a secret key, ciphers the decoded user key by using a first cipher function of the device, and stores the user key in the semiconductor memory.

18. The system according to claim 17,
wherein the host apparatus decodes the ciphered user key stored in the host memory of the host apparatus by using a conversion function to obtain the user key, and
the device decodes the ciphered user key stored in the semiconductor memory of the device by using the first cipher function of the device to obtain the user key.

19. A memory system comprising:
the device recited in claim 1; and
the host apparatus accessible to the device,
wherein the host apparatus includes:
a host memory which is configured to store a user key; and
a host controller which controls the device,
wherein the host apparatus initializes the device, and then checks whether the device is in the locked state or the unlocked state,
wherein the device is in the unlocked state, the host apparatus sets a first user key to the device and enables a first mode for registering the user key for the device in the locked state,
wherein the device is in the locked state due to a user key has been set to the device, the host apparatus which has the first user key transmits the first user key to the device to change the device to the unlocked state, and enables the first mode if the device changes to the unlocked state with the first user key, and
wherein the device is in the locked state and in the first mode, the host apparatus which has a second user key registers the second user key to the device in the first mode and then disable the first mode,
wherein when the user key is authenticated,
the host apparatus ciphers the user key by using a third cipher function and a random number supplied by the device,
the device authenticates the user key ciphered by the host apparatus, by using the third cipher function, the random number, and the ciphered user key stored in the semiconductor memory, and
when the authentication is successful, the device changes from the locked state to the unlocked state.
